(19) United States
(12) Patent Application Publication
(10) Pub. No.: US 2026/0289560 A1
(43) Pub. Date: Sep. 24, 2026

(54) METHODS AND SYSTEMS FOR SECURE AND REVERSIBLE COMBINATION ON-AND-OFF CHAIN TRANSACTIONS

(71) Applicant: NIVAC LLC, Casper, WY (US)

(72) Inventors: Matthew Cullen CAVIN, Bellevue, WA (US); Rebecca Marie CAVIN, Bellevue, WA (US)

(73) Assignee: NIVAC LLC, Casper, WY (US)

(21) Appl. No.: 19/683,112

(22) Filed: May 20, 2026

Related U.S. Application Data
(63) Continuation of application No. PCT/US2024/056613, filed on Nov. 20, 2024.
(60) Provisional application No. 63/600,742, filed on Nov. 20, 2023.

(51) Int. Cl. G06Q 20/38; G06Q 20/36; G06Q 20/40

(52) U.S. Cl. CPC G06Q 20/389; G06Q 20/367; G06Q 20/401

(57) ABSTRACT

A central service method for transaction integrity for an on-chain order fulfilment with an off-chain payment includes receiving, by a receiving device, at least one dispute-related structured data set associated with the off-chain payment, wherein the dispute-related structured data set includes at least one data element; processing the transaction message with one or more processing devices; storing, in at least one storage environment, one or more of the extracted dispute data element, the dispute extracted metadata element, and the generated dispute metadata element relating to the received dispute-related structured data set, wherein the stored data element indicates a change from a first state to a second state; querying the data storage environment for a present state via code on a blockchain, wherein the code on the blockchain is further configured to automatically execute a method surviving execution when the queried present state matches a predetermined trigger condition.

### CROSS REFERENCE TO RELATED APPLICATIONS

This application is a continuation of International Application No. PCT/US2024/056613 filed Nov. 20, 2024, which claims the benefit of U.S. Provisional Application No. 63/600,742 filed Nov. 20, 2023, which are hereby incorporated by reference in their entirety.

### FIELD OF THE INVENTION

The present invention is generally related to the area of transactions in finance, and more specifically to securely electronically communicating the status of an off-chain fiat-based payment transaction (or absence thereof) into a blockchain-based network for automated order fulfilment with pre-defined trigger conditions to reverse a transaction according to payment state data. In this way, it allows for acceptance of fiat payments and the use of traditional payment rails while enabling order fulfilment via a blockchain. The present invention is also generally related to maintaining transaction integrity (buyer and seller protections in such transactions) by monitoring state data verifying a transaction for a change in state matching a trigger condition indicating a chargeback event and in response to determining such a trigger condition has occurred, performing a method surviving execution to reverse the transaction.

### BACKGROUND OF THE INVENTION

In recent times, blockchain assets have seen increased usage, utility, and adoption. Digital assets are increasingly presented as non-fungible tokens (NFTs), each a unique numeric or alphanumeric series that, unlike cryptocurrency, represent a specific tangible or intangible asset or set thereof. NFTs are tokenized proof of title to a unique digital version of (an) underlying asset(s). They may also ensure the provenance of underlying asset(s) via a unique set of numbers (the “token”) which may create factual control of linked asset(s) in a manner akin to property rights. NFTs may be a tokenized real-world asset (RWA) that may be compatible with on-chain protocols. NFTs (which may represent proof of title, right, licenses, membership, subscriptions etc.) may also have utility on a chain, such as the ability to be utilized as collateral, security, yield generation, or a settlement mechanism.

Unlike fungible tokens such as cryptocurrencies (e.g., ERC-20 standard tokens representing assets or utilities such as Ethereum ($ETH), Bitcoin ($BTC), US Dollar Coin ($USDC) and the like), each non-fungible token has a distinct value, is not interchangeable, and may represent proof of title or rights.

To-date, NFTs are perhaps best known for representing virtual artwork, where the NFT serves as a certificate of authenticity, provenance, and/or ownership. However, the utility of NFTs has recently extended to digital fashion, in-game assets, video media, online ticketing, club membership, automotive title, real property title, rental rights, and more.

Recently, the utility of NFTs has been further extended to enable “dynamic NFT” (dNFT) experiences. A dynamic NFT is encoded with smart contract logic that enables it to automatically change its metadata based on external conditions; i.e., retaining its tokenID while updating aspects of its metadata, even if such metadata post-dates the minting of the dNFT. Dynamic NFTs may utilize standards such as ERC-721, ERC-721A, and ERC-1155.

Additionally, NFT technology has evolved such that a given NFT can own other tokens after the given NFT is already minted, as in the case of ERC-6551, a non-fungible token-bound account. It is also now commonplace to see “token gated” experiences and applications, which require one to hold a particular NFT (or crafted set thereof) in order to access an application or experience. Additionally, blockchain wallet technology has evolved such that a given wallet (an externally-owned or accessible account, or EOA) can be managed by or associated with a smart contract, which may create a related wallet, as in the case of ERC-4337 and EIP-7702.

Despite these innovations, the purchase, sale, and transfer of NFTs are typically executed via contracts that presume on-chain consideration, priced as such (e.g., an ERC-721 or ERC-1155 token priced in $ETH). This requires the buyer to procure cryptocurrency.

Many potential buyers, however, lack crypto wallets and ERC-20 tokens (e.g., $ETH) to use for consideration when buying an NFT. It is not possible to directly facilitate a payment from a credit or debit card within a blockchain contract—they're separate environments (one on-chain and decentralized; the other off-chain and centralized) which are thought by those of skill in the art to be incompatible due to their antithetical structuring.

However, the process of procuring cryptocurrency to purchase a digital item remains cumbersome, particularly for mainstream consumers unaccustomed to digital currencies. Such a transaction either requires a buyer to procure an on-chain fungible asset (e.g., $ETH) for use as consideration in the transaction, or for both parties to enlist an intermediate custodian to escrow a digital asset while payment is arranged off chain (e.g., a hot wallet arrangement). Both alternatives introduce friction and risk to the buyer and seller.

Therefore, a prospective buyer of an NFT must first create a digital wallet (deciding amongst physical and virtual offerings that are custodial, noncustodial, multi-party computation, etc.), such as MetaMask® or Ledger®; and second “fund” their wallet by transferring fiat currency into cryptocurrency, for a fee, offered by a third party (known as an “on-ramp”), whose services may be powered by licensed money transmitters, exchanges (centralized or decentralized), market makers, or other service providers.

This “on ramp” process is simply impractical for most consumers; it results in very high decline rates and introduces unnecessary friction and regulatory risk likely unacceptable to mainstream merchants or marketplaces. In addition, consumers themselves may be reluctant to procure or utilize cryptocurrencies, which can be difficult to understand, particularly in relation to well-known fiat currencies. Moreover, for each “on ramp,” consumers may be required to undertake multiple duplicative processes for “know your customer”/“know your business” (KYC/KYB) and/or anti-money laundering/combatting terrorist financing (AML/CTF) requirements (such as identity and/or address verifications), despite having already done the same with their bank. Moreover, this process creates additional economic loss to the buyer of an NFT, via ramp fees and/or spreads on exchanges—a loss of value simply by funding a wallet.

Furthermore, even after buyers procure the requisite cryptocurrency to execute the transaction, service providers (such as “on ramps”) face significant risk of card reversals, refunds, disputes, and chargebacks. Blockchain itself does not provide sufficient consumer protections or dispute resolution that is typical of many fiat payment networks. That is, after the service provider has immutably and irrevocably delivered the cryptocurrency or the NFT to the buyer's blockchain wallet, the buyer remains able to submit a “chargeback” claim to their card issuer with respect to the service provider (the merchant of record), typically for up to 120 days following the transaction. Although the banks and card networks could address this dispute by observing an on-chain transfer to invalidate the claim (a straightforward technical process, albeit one for which may banks are ill-equipped), the cost of such investigation (often $10-$200 in chargeback fees) may exceed the purchase price itself, as would the time and personnel costs of resolution.

Thus, there is a significant and long-felt need to improve on the processing of transactions that utilize fiat currencies as consideration for the transfer of non-currency blockchain assets (such as non-fungible or semi-fungible tokens) on public blockchains.

Additionally, there is a significant and long-felt need for an efficient mechanism to match an off-chain fiat payment event (e.g., a credit/debit/prepaid card authorized via a card network (or an “on-us” issuer/acquirer) with on-chain order fulfillment (irrevocable transfer of title to buyer in a public blockchain environment).

Moreover, there is a significant and long-felt need for an efficient mechanism to protect a seller or service provider against chargeback risk, should the order be disputed after having already been immutably fulfilled on a blockchain.

Finally, there is a significant and long-felt need for an efficient mechanism to enable multiple parties, such as buyers alongside lenders, to jointly purchase with fiat certain goods, services, rights, titles, and/or licenses that may be held in blockchain wallet(s), in such a way that may codify the parties' shared interest in an asset (such as a primary lien).

Existing payment networks and payment processing systems that utilize fiat currency are familiar and frequently used by average consumers, while on-chain payment networks and payment processing is unfamiliar and has several (also unfamiliar) intermediate steps making it difficult to access. Accordingly, consumers and merchants can benefit from the use of traditional payment networks and payment systems in combination with blockchain non-fungible tokens, which are or represent assets, without any reliance on cryptocurrency or the burden of a third party service to convert fiat into cryptocurrency. Though nonfungible and semi-fungible tokens are highly useful to immutably confer asset ownership, the use of an ERC-20 (fungible (i.e. cryptocurrency) token) as consideration creates significant complications and raises barriers to mainstream adoption; as described herein, applicants have unexpectedly discovered that traditional payment networks and payment systems could be utilized with an intermediate service to efficiently execute an NFT transfer and protect sellers against the risk of disputes in such transfers.

### SUMMARY OF THE INVENTION

In an aspect, this disclosure broadly comprises a central service method for securely electronically transmitting the results of an off-chain fiat-based payment transaction (or absence thereof) into to a blockchain-based network for automated order fulfilment with automated trigger conditions to reverse a transaction according to payment state data. This includes receiving, by a receiving device, at least one transaction message associated with the off-chain payment transaction, wherein the transaction message includes at least one data element and/or at least one metadata element; processing the transaction message with one or more processing devices, to perform at least one of extracting, from the transaction message, at least one extracted data element, extracting, from the transaction message, at least one extracted metadata element, and generating, from the at least one extracted data element and/or the at least one extracted metadata element, at least one generated metadata element; storing, in at least one storage environment, one or more of the extracted data element, the extracted metadata element, and the generated metadata element relating to the received transaction message; generating, on a blockchain, at least one token and/or at least one smart contract, wherein the at least one token and/or smart contract can access the at least one storage environment storing one or more of the extracted data element, the extracted metadata element, and the generated metadata element relating to the received transaction message.

In a configuration, the at least one token and/or smart contract includes at least one method surviving execution.

In a configuration, the off-chain payment transaction and the on-chain order fulfilment do not comprise cryptocurrency.

In a configuration, the transaction message is formatted according to one or more standards.

In a configuration, the one or more standards comprise ISO 8583:2023 and ISO 20022:2013.

In a configuration, the transaction message comprises a communication of at least one of a settlement guarantee and a settlement confirmation by a payment network and/or by at least one member of the payment network.

In a configuration, the communication of a settlement guarantee comprises at least one of an authorization response message and a pre-authorization response message.

In a configuration, the at least one data element comprises at least one data element reserved for private use.

In a configuration, the at least one data element reserved for private use is a reference identifier.

In a configuration, the reference identifier references a smart contract and/or an NFT.

In a configuration, the at least one generated metadata element includes authorization response data pertaining to the off-chain payment transaction.

In a configuration, the blockchain is a public blockchain.

In a configuration, the at least one token is at least one of a dynamic non-fungible token, a semi-fungible token, a non-fungible token-bound account, a wallet, an account, and a smart contract.

In a configuration, the dynamic non-fungible token is generated according to ERC-721 (24 Jan. 2018).

In a configuration, the semi-fungible token is generated according to ERC-1155 (17 Jun. 2018).

In a configuration, the non-fungible token-bound account is generated according to ERC-6551 (23 Feb. 2023).

In a configuration, generating the at least one token occurs prior to receiving the transaction message.

In a configuration, generating the at least one token occurs after receiving the transaction message.

In a configuration, the token and/or smart contract automatically updates based on the stored and accessed extracted data element, extracted metadata element, and/or generated metadata element relating to the received transaction message.

In a configuration, the token and/or smart contract automatically updating includes the smart contract automatically executing itself.

In a configuration, the smart contract automatically executing itself includes a creation and/or transfer of at least one NFT to an account and/or wallet accessible to the buyer pursuant to a transfer of fiat to an account and/or wallet accessible to the seller.

In a configuration, at least one of the extracted data elements, the extracted metadata elements, and the generated metadata elements comprise one or more of information about the smart contract, information about an item being transferred, a categorization, information about the parties to the smart contract, information about the terms of the smart contract, and information about the transaction message.

In a configuration, information about the smart contract comprises one or more of a contractID for the smart contract, a tokenID for the token, and a description of the smart contract.

In a configuration, information about the item being transferred comprises one or more of data and/or metadata reflecting stock-keeping unit information for at least one NFT or the at least one item represented by the NFT.

In a configuration, the information about the item being transferred comprises one or more of data and/or metadata reflecting know-your-customer and/or know-your-business information for the buyer and/or seller of the at least one NFT or the at least one item represented by the NFT.

In a configuration, the categorization comprises at least one of a merchant category code and a transaction type indicator.

In a configuration, the information about the parties to blockchain contract comprises one or more of a least one wallet address, association of a seller fiat account to a seller off-chain wallet, and association of a buyer fiat account to a buyer on-chain wallet.

In a configuration, information about the terms of the smart contract comprises one or more of state data, method(s) governing execution, and method(s) surviving execution.

In a configuration, the smart contract is amendable after execution upon approval of the buyer and seller to the amendment.

In a configuration, the method further comprises receiving two or more transaction messages and determining, with the processor, whether the two or more transaction messages are in agreement.

In a configuration, after the processor determines that the two or more transaction messages are in agreement, the one or more of the extracted data element, the extracted metadata element, and the generated metadata element relating to the received transaction messages are stored in the storage environment.

In a configuration, the storage environment is off-chain.

In a configuration, the storage environment is on a blockchain.

In a configuration, receiving the transaction message includes observing a transaction message via access to an entity receiving, observing, or sending the transaction message as part of the off-chain payment transaction.

In a configuration, the transaction message comprises a payment message.

In a configuration, the payment message comprises one or more of an authorization request, authorization response, authorization advice, authorization repeat, authorization advice response, authentication request, authentication response, clearing request, clearing response, settlement request, settlement response, payment confirmation request, payment confirmation response, recurring payment request, recurring payment response, sale, completion, refunds, and force.

In a configuration, the payment message comprises one or more of a payment initiation message schema, acmt, admi, auth, caaa, caad, caam, cafc, cafm, cafr, cain, camt, canm, casp, casr, catm, catp, colr, fxtr, head, pacs, pain, reda, remt, secl, seev, semt, sese, setr, tsin, tsmt, and/tsrv.

In a configuration, the payment message is formatted according to at least one of OBIE UK, FedNow, UK Faster Payment Scheme, CFPA Section 1033, and SWIFT

In a configuration, the transaction message comprises an authentication message.

In a configuration, the authentication message comprises a result of an 3DS (2001) or 3DS2.0 (2016) authentication attempt.

In a configuration, the result signifies the occurrence or non-occurrence of a liability shift.

In a configuration, the transaction message comprises a card-linked offer message.

In a configuration, the transaction message comprises an open banking message.

In a configuration, the transaction message comprises a real-time payment message.

In a configuration, the transaction message comprises a peer-to-peer or staged digital wallet message.

In a configuration, the transaction message comprises cross-border payment message.

In a configuration, the transaction message comprises an electronic funds transfer message.

In a configuration, the method further comprises creating the smart contract.

In a configuration, the method further comprises receiving approval of the buyer and seller to the smart contract.

In a configuration, the method further comprises compiling the smart contract.

In a configuration, the method further comprises deploying the smart contract on the blockchain.

In a configuration, the method further comprises communicating one or more of information about the smart contract, information about the item being transferred, a categorization, information about the parties to the smart contract, and information about the terms of the smart contract to a/the payment network and/or to at least one member of the payment network.

In a configuration, the communicating step allows the payment network and/or member of the payment network to apply a merchant category code or transaction type indicator to the transaction other than quasi-cash or digital goods.

In a configuration, the at least one method surviving execution comprises a temporary method which persists for a time period.

In a configuration, the time period is absolute or relative to a date associated with the smart contract.

In a configuration, the temporary method comprises one or more of a holding period, a dispute call, a warranty, a return policy, an insurance requirement, an insurance policy, a tax obligation, a lien on the item, and a dependency to execute at least one other contract within a follow-on time period.

In a configuration, the follow-on time period is predetermined or relative to a date associated with the smart contract.

In a configuration, the at least one method surviving execution comprises a non-temporary method.

In a configuration, the non-temporary method comprises one or more of a permanent record of ownership of a/the at least one NFT, a lien on the item, and an insurance policy.

In a configuration, the method surviving execution comprises an override provision.

In a configuration, the smart contract comprises at least one wallet address.

In a configuration, the smart contract comprises at least one function.

In a configuration, the smart contract comprises at least one method governing execution.

In a configuration, the at least one method governing execution comprises one or more of a required value to be achieved by state data, an on-chain signature, and a timelock key.

In a configuration, the required value to be achieved by state data indicates a/the settlement guarantee or confirmation by a/the payment network and/or by at least one member of the payment network.

In a configuration, the required value to be achieved by state data is one or more of authorized, approved, authenticated, confirmed, cleared, and settled.

In a configuration, the method further comprises receiving and/or creating at least one transaction confirmation data element.

In a configuration, the transaction confirmation data element comprises one or more address, topics, data, blockNumber, timestamp, gasPrice, gasUsed, logIndex, transactionHash, and/or transactionIndex.

In a configuration, the method further comprises performing confirmatory processing to validate successful delivery of the NFT.

In a configuration, performing confirmatory processing to validate successful delivery of the NFT comprises performing a getOwnersForToken function, wherein the getOwnersForToken function returns a return wallet address.

In a configuration, performing confirmatory processing to validate successful delivery of the NFT further comprises determining the NFT has been successfully delivered if the return wallet address matches the account and/or wallet accessible to the buyer.

In a configuration, the method further comprises communicating the at least one transaction confirmation data element to one or more of a sender from whom the transaction message was received, the payment network, and/or the member of the payment network.

In a configuration, communicating the at least one transaction confirmation data element is performed after confirmatory processing to validate successful delivery of the NFT.

In a configuration, communicating the at least one transaction confirmation data comprises formatting the at least one transaction confirmation data as a chargeback rebuttal data feed.

In a configuration, the method further comprises: receiving, by the receiving device, at least one dispute-related transaction message associated with the off-chain payment transaction, wherein the transaction message includes at least one dispute data element and/or at least one dispute metadata element; processing the dispute-related transaction message by the one or more processing devices, to perform at least one of: extracting, from the dispute-related transaction message, at least one extracted dispute data element, extracting, from the dispute-related transaction message, at least one extracted dispute metadata element, and generating, from the at least one extracted dispute data element and/or the at least one extracted dispute metadata element, at least one generated dispute metadata element; storing, in the at least one storage environment, one or more of the extracted dispute data element, the dispute extracted metadata element, and the generated dispute metadata element relating to the received dispute-related transaction message; wherein the data storage environment is checked by the at least one token and/or the at least one smart contract, further wherein the at least one smart contract comprises the at least one method surviving execution configured to programmatically execute upon the checking satisfying a predetermined condition.

In a configuration, the predetermined condition is that at least one of the stored extracted dispute data element, dispute extracted metadata element, and generated dispute metadata element indicates that at least one of a/the payment network or a/the member of a payment network has approved a chargeback.

In a configuration, the at least one method surviving execution operates to remove a/the NFT from the/an account and/or wallet accessible to the buyer.

In a configuration, the at least one method surviving execution operates to suspend functionality of a/the at least one NFT from the/an account and/or wallet accessible to the buyer.

In a configuration, removing the at least one NFT comprises one of burning the NFT, returning the NFT to the seller, and escrowing the NFT.

In a configuration, suspending functionality comprises one or more of disabling the NFT, removing a connection to at least a part of the data storage environment, modifying a metadata element of the NFT, and modifying one or more data elements stored in the data storage environment.

In a configuration, the method further comprises producing a disputes report.

In a configuration, the method further comprises communicating the dispute report to the payment network and/or at least one member of the payment network.

In a configuration, the buyer comprises a main buyer and one or more lender-buyers.

In a configuration, the payment network comprises an escrow account.

In a configuration, the transaction message indicates the settlement guarantee or confirmation of an at least partially off-chain payment transaction into the escrow account by the main buyer.

In a configuration, the method(s) governing execution cause the smart contract to programmatically execute to transfer, send, or call payment from the one or more lender-buyers, transfer, send, or call the at least one NFT to an account and/or wallet accessible to the main buyer, and transfer, send, or call some or all of the escrow payment and/or the pulled payment to an account and/or wallet accessible to the seller.

In a configuration, the method(s) surviving execution comprise a function to transfer, send, or call the at least one NFT to an account and/or wallet accessible to the at least one lender-buyers.

In another aspect, the disclosure broadly comprises a central service system to securely electronically transmitting the results of an off-chain fiat-based payment transaction (or absence thereof) into to a blockchain-based network for automated order fulfilment with automated trigger conditions to reverse a transaction according to payment state data comprising: a receiving device configured to receive at least one transaction message associated with the off-chain payment transaction, wherein the transaction message includes at least one data element and/or at least one metadata element; one or more processors associated with the receiving device and configured to process the transaction message by performing at least one of: extracting, from the transaction message, at least one extracted data element; extracting, from the transaction message, at least one extracted metadata element; and generating, from the at least one extracted data element and/or the at least one extracted metadata element, at least one generated metadata element; a storage environment associated with the processor and the receiving device, the storage environment configured to store one or more of the extracted data element, the extracted metadata element, and the generated metadata element relating to the received transaction message; a generation processor configured to generate, on a blockchain, at least one token and/or at least one smart contract, wherein the at least one token and/or smart contract can access the at least one storage environment storing one or more of the extracted data element, the extracted metadata element, and the generated metadata element relating to the received transaction message.

In a configuration, the processor and the generation processor are the same processor.

In a configuration, the processor and the generation processor are different processors.

In a configuration, the processor and the generation processor are networked together.

In a configuration, the at least one token and/or smart contract includes at least one method surviving execution.

In a configuration, the off-chain payment transaction and the on-chain order fulfilment do not comprise cryptocurrency.

In a configuration, the transaction message is formatted according to one or more standards.

In a configuration, the one or more standards comprise ISO 8583:2023 and ISO 20022:2013.

In a configuration, the transaction message comprises a communication of at least one of a settlement guarantee and a settlement confirmation by a payment network and/or by at least one member of the payment network.

In a configuration, the communication of a settlement guarantee comprises at least one of an authorization response message and a pre-authorization response message.

In a configuration, the at least one data element comprises at least one data element reserved for private use.

In a configuration, the at least one data element reserved for private use is a reference identifier.

In a configuration, the reference identifier references a smart contract.

In a configuration, the at least one generated metadata element includes authorization response data pertaining to the status of the off-chain payment transaction.

In a configuration, the blockchain is a public blockchain.

In a configuration, the at least one token is at least one of a non-fungible token, a dynamic non-fungible token, a semi-fungible token, a non-fungible token-bound account, a wallet, an account, a smart contract wallet, and a smart contract.

In a configuration, the non-fungible token is generated according to ERC-721 (24 Jan. 2018).

In a configuration, the semi-fungible token is generated according to ERC-1155 (17 Jun. 2018).

In a configuration, the non-fungible token-bound account is generated according to ERC-6551 (23 Feb. 2023).

In a configuration, the wallet is generated according to ERC-4337 (29 Sep. 2021).

In a configuration the wallet is generated according to EIP-7702 (7 May 2024)

In a configuration, the generation processor is configured to generate the at least one token prior to receiving the transaction message.

In a configuration, the generation processor is configured to generate the at least one token after receiving the transaction message.

In a configuration, the token and/or smart contract automatically updates based on the stored and accessed extracted data element, extracted metadata element, and/or generated metadata element relating to the received transaction message.

In a configuration, the token and/or smart contract automatically updating includes the smart contract automatically executing itself.

In a configuration, the smart contract automatically executing itself includes a creation and/or transfer of at least one NFT to an account and/or wallet accessible to the buyer pursuant to a transfer of fiat to an account and/or wallet accessible to the seller.

In a configuration, at least one of the extracted data elements, the extracted metadata elements, and the generated metadata elements comprise one or more of information about the smart contract, information about the item being transferred, a categorization, information about the parties to the smart contract, information about the terms of the smart contract, and information about the transaction message.

In a configuration, information about the smart contract comprises one or more of a contractID for the smart contract, a tokenID for the token, and a description of the smart contract.

In a configuration, the information about the item being transferred comprises one or more of data and/or metadata reflecting stock-keeping unit information for at least one NFT or the at least one item represented by the NFT.

In a configuration, the information about the item being transferred comprises one or more of data and/or metadata reflecting know-your-customer and/or know-your-business information for the buyer and/or seller of the at least one NFT or the at least one item represented by the NFT.

In a configuration, the categorization comprises at least one of a merchant category code and a transaction type indicator.

In a configuration, the information about the parties to blockchain contract comprises one or more of a least one wallet address, association of a seller fiat account to a seller off-chain wallet, and association of a buyer fiat account to a buyer on-chain wallet.

In a configuration, information about the terms of the smart contract comprises one or more of state data, method(s) governing execution, and method(s) surviving execution.

In a configuration, the smart contract is amendable after execution upon approval of the buyer and seller to the amendment.

In a configuration, the receiving device is further configured to receive two or more transaction messages and the processor is further configured to determine whether the two or more transaction messages are in agreement.

In a configuration, the storage environment is configured to store one or more of the extracted data element, the extracted metadata element, and the generated metadata element relating to the received transaction messages only after the processor has determined that the two or more transaction messages are in agreement.

In a configuration, the storage environment is off-chain.

In a configuration, the storage environment is on a blockchain.

In a configuration, receiving the transaction message includes observing a transaction message via access to an entity receiving, observing, or sending the transaction message as part of the off-chain payment transaction.

In a configuration, the transaction message comprises a payment message.

In a configuration, the payment message comprises one or more of an authorization request, authorization response, authorization advice request, authorization repeat, authorization advice response, authentication request, authentication response, clearing request, clearing response, settlement request, settlement response, payment confirmation request, payment confirmation response, recurring payment request, recurring payment response, sale, completion, refunds, and force.

In a configuration, the payment message comprises one or more of a payment initiation message schema, acmt, admi, auth, caaa, caad, caam, cafc, cafm, cafr, cain, camt, canm, casp, casr, catm, catp, colr, fxtr, head, pacs, pain, reda, remt, secl, seev, semt, sese, setr, tsin, tsmt, and/tsrv.

In a configuration, the payment message is formatted according to at least one of OBIE UK, FedNow, UK Faster Payment Scheme, CFPA Section 1033, and SWIFT.

In a configuration, the transaction message comprises an authentication message.

In a configuration, the authentication message comprises a result of an 3DS (2001) or 3DS2.0 (2016) authentication transaction message.

In a configuration, the transaction message comprises a liability shift data element.

In a configuration, the transaction message comprises a card-linked offer data element.

In a configuration, the transaction message comprises an open banking data element.

In a configuration, the transaction message comprises a real-time payment data element.

In a configuration, the transaction message comprises a peer-to-peer or staged digital wallet data element.

In a configuration, the transaction message comprises cross-border payment data element.

In a configuration, the transaction message comprises an electronic funds transfer data element.

In a configuration, the system further comprises a contract processor configured to create the smart contract.

In a configuration, the contract processor is the same as the processor and/or the generation processor.

In a configuration, the contract processor is different from the processor and/or the generation processor.

In a configuration, the contract processor is networked with at least one of the processor and the generation processor.

In a configuration, each or any of the contract processor, the generation processor and the communication processor comprise one or more processors.

In a configuration, the contract processor is further configured to receive approval of the buyer and seller to the smart contract.

In a configuration, the contract processor is further configured to compile the smart contract.

In a configuration, the contract processor is further configured to deploy the smart contract on the blockchain.

In a configuration, at least one of the processor, the generation processor and the contract processor is configured to communicate one or more of information about the smart contract, information about the item being transferred, a categorization, information about the parties to the smart contract, and information about the terms of the smart contract to a/the payment network and/or to at least one member of the payment network

In a configuration, the communication allows the payment network and/or member of the payment network to apply a merchant category code or transaction type indicator to the transaction other than quasi-cash or digital goods.

In a configuration, the at least one method surviving execution comprises a temporary method which persists for a time period.

In a configuration, the time period is absolute or relative to a date associated with the smart contract.

In a configuration, the temporary method comprises one or more of a holding period, a dispute call, a warranty, a return policy, an insurance requirement, an insurance policy, a tax obligation, a third-party lien or claim on the item, and a dependency to execute at least one other contract within a follow-on time period.

In a configuration, the follow-on time period is predetermined or relative to a date associated with the smart contract.

In a configuration, the at least one method surviving execution comprises a non-temporary method.

In a configuration, the non-temporary method comprises one or more of a permanent record of ownership of a/the at least one NFT, a lien on the item, and an insurance policy.

In a configuration, the method surviving execution comprises an override provision.

In a configuration, the smart contract comprises at least one wallet address.

In a configuration, the smart contract comprises at least one function.

In a configuration, the smart contract comprises at least one method governing execution.

In a configuration, the at least one method governing execution comprises one or more of a required value to be achieved by state data, an on-chain signature, and a timelock key.

In a configuration, the required value to be achieved by state data indicates a/the settlement guarantee or confirmation by a/the payment network and/or by at least one member of the payment network.

In a configuration, the required value to be achieved by state data is one or more of authorized, approved, authenticated, confirmed, cleared, and settled.

In a configuration, the system further comprises the receiving device or a second receiving device configured to receive an at least one transaction confirmation data element.

In a configuration, the system further comprises the contract processor or generation processor configured to create a/the at least one transaction confirmation data element.

In a configuration, the transaction confirmation data element comprises one or more address, topics, data, blockNumber, timestamp, gasPrice, gasUsed, logIndex, transactionHash, and/or transactionIndex.

In a configuration, the system further comprises wherein the contract processor is configured to perform confirmatory processing to validate successful delivery of the NFT.

In a configuration, the contract processor is further configured to perform confirmatory processing by performing a getOwnersForToken function, wherein the getOwnersForToken function returns a return wallet address.

In a configuration, the contract processor is further configured to perform confirmatory processing by making a determination that the NFT has been successfully delivered if the return wallet address matches the account and/or wallet accessible to the buyer.

In a configuration, the system further comprises a communication processor configured to communicate at least one transaction confirmation data element to one or more of a sender from whom the transaction message was received, the payment network, and/or the member of the payment network.

In a configuration, the communication processor is configured to communicate the at least one transaction confirmation data element after confirmatory processing to validate successful delivery of the NFT.

In a configuration, the communication processor is configured to communicate the at least one transaction confirmation data element by formatting the at least one transaction confirmation data as a chargeback rebuttal data feed.

In a configuration, the system further comprises the receiving device further configured to receive at least one dispute-related transaction message associated with the off-chain payment transaction, wherein the dispute-related transaction message includes at least one dispute data element and/or at least one dispute metadata element; the processor configured to perform at least one of: extracting, from the dispute-related transaction message, at least one extracted dispute data element, extracting, from the dispute-related transaction message, at least one extracted dispute metadata element, and generating, from the at least one extracted dispute data element and/or the at least one extracted dispute metadata element, at least one generated dispute metadata element; the at least one storage environment further configured to store one or more of the extracted dispute data element, the dispute extracted metadata element, and the generated dispute metadata element relating to the received dispute-related transaction message; wherein the at least one token and/or the at least one smart contract are further configured to automatically check the data storage environment, and further wherein the at least one smart contract comprises the at least one method surviving execution configured to programmatically execute upon the checking satisfying a predetermined trigger condition.

In a configuration, the predetermined trigger condition is that at least one of the stored extracted dispute data element, dispute extracted metadata element, and generated dispute metadata element indicates that at least one of a/the payment network or a/the member of a payment network has approved a chargeback.

In a configuration, the at least one method surviving execution operates to remove a/the NFT from the/an account and/or wallet accessible to the buyer.

In a configuration, the at least one method surviving execution operates to suspend functionality of a/the at least one NFT from the/an account and/or wallet accessible to the buyer.

In a configuration, removing the at least one NFT comprises one of burning the NFT, returning the NFT to the seller, and escrowing the NFT.

In a configuration, suspending functionality comprises one or more of disabling the NFT, removing a connection to at least a part of the data storage environment, modifying a metadata element of the NFT, and modifying one or more data elements stored in the data storage environment.

In a configuration, the system further comprises producing a disputes data feed.

In a configuration, at least one of the processor, the generation processor and the contract processor is configured to communicate the dispute data feed to the payment network and/or at least one member of the payment network.

In a configuration, the buyer comprises a main buyer and one or more lender-buyers.

In a configuration, the payment network comprises an escrow account.

In a configuration, the transaction message indicates the liability state data or confirmation of an at least partially off-chain payment transaction into the escrow account by the main buyer.

In a configuration, the method(s) governing execution cause the smart contract to programmatically execute to transfer, send, or call payment from the one or more lender-buyers, transfer, send, or call the at least one NFT to an account and/or wallet accessible to the main buyer, and transfer, send, or call some or all of the escrow payment and/or the pulled payment to an account and/or wallet accessible to the seller.

In a configuration, the method(s) surviving execution comprise a function to transfer, send, or call the at least one NFT to an account and/or wallet accessible to the at least one lender-buyers.

In another aspect, the disclosure broadly comprises a central service method for securely electronically transmitting the results of an off-chain fiat-based payment transaction (or absence thereof) into to a blockchain-based network for automated order fulfilment with automated trigger conditions to reverse a transaction according to payment state data comprising: receiving, by a receiving device, at least one dispute-related transaction message associated with the off-chain payment transaction, wherein the dispute-related transaction message includes at least one dispute data element and/or at least one dispute metadata element; processing the dispute-related transaction message by one or more processing devices, to perform at least one of: extracting, from the dispute-related transaction message, at least one extracted dispute data element, extracting, from the dispute-related transaction message, at least one extracted dispute metadata element, and generating, from the at least one extracted dispute data element and/or the at least one extracted dispute metadata element, at least one generated dispute metadata element; storing, in at least one storage environment, one or more of the extracted dispute data element, the dispute extracted metadata element, and the generated dispute metadata element relating to the received dispute-related transaction message; wherein the data storage environment is checked by at least one token and/or at least one smart contract, further wherein the at least one smart contract comprises at least one method surviving execution configured to programmatically execute upon the checking satisfying a predetermined condition.

In a configuration, the off-chain payment transaction and the on-chain order fulfilment do not comprise cryptocurrency.

In a configuration, the predetermined condition is at least one of the stored extracted dispute data element, dispute extracted metadata element, and generated dispute metadata element indicates that at least one of a payment network or a member of a payment network has approved a chargeback.

In a configuration, the at least one method surviving execution operates to remove at least one NFT from an account and/or wallet accessible to the buyer.

In a configuration, the at least one method surviving execution operates to suspend functionality of at least one NFT from an account and/or wallet accessible to the buyer.

In a configuration, removing the at least one NFT comprises one of burning the NFT, returning the NFT to the seller, and escrowing the NFT.

In a configuration, suspending functionality comprises one or more of disabling the NFT, removing a connection to at least a part of the data storage environment, modifying a metadata element of the NFT, and modifying one or more data elements stored in the data storage environment.

In a configuration, the method further comprises producing a disputes data feed.

In a configuration, the method further comprises communicating the dispute data feed to the payment network and/or at least one member of the payment network.

In a configuration, the on-chain order fulfilment is on a public blockchain.

In another aspect, the disclosure broadly comprises a central service system for addressing instances of disputes relating to an off-chain payment transaction for an on-chain order fulfilment for the benefit of a buyer and a seller comprising: a receiving device configured to receive at least one dispute-related transaction message associated with the off-chain payment transaction, wherein the dispute-related transaction message includes at least one dispute data element and/or at least one dispute metadata element; at least one processor configured to process the dispute-related transaction message to perform at least one of: extracting, from the dispute-related transaction message, at least one extracted dispute data element, extracting, from the dispute-related transaction message, at least one extracted dispute metadata element, and generating, from the at least one extracted dispute data element and/or the at least one extracted dispute metadata element, at least one generated dispute metadata element; at least one storage environment, one or more of the extracted dispute data element, the dispute extracted metadata element, and the generated dispute metadata element relating to the received dispute-related transaction message; at least one token and/or at least one smart contract configured to check the storage environment, wherein the at least one smart contract comprises at least one method surviving execution configured to programmatically execute upon the checking satisfying a predetermined condition.

In a configuration, the off-chain payment transaction and the on-chain order fulfilment do not comprise cryptocurrency.

In a configuration, the predetermined condition is at least one of the stored extracted dispute data element, dispute extracted metadata element, and generated dispute metadata element indicates that at least one of a payment network or a member of a payment network has approved a chargeback.

In a configuration, the at least one method surviving execution operates to remove at least one NFT from an account and/or wallet accessible to the buyer.

In a configuration, the at least one method surviving execution operates to suspend functionality of at least one NFT from an account and/or wallet accessible to the buyer.

In a configuration, removing the at least one NFT comprises one of burning the NFT, returning the NFT to the seller, and escrowing the NFT.

In a configuration, suspending functionality comprises one or more of disabling the NFT, removing a connection to at least a part of the data storage environment, modifying a metadata element of the NFT, and modifying one or more data elements stored in the data storage environment.

In a configuration, the at least one processor is further configured to produce a disputes report.

In a configuration, the at least one processor is configured to communicate the dispute report to the payment network and/or at least one member of the payment network.

In a configuration, the on-chain order fulfilment is on a public blockchain.

In another aspect, the disclosure broadly comprises a method of creating a smart contract for an off-chain payment transaction and an on-chain order fulfilment comprising: receiving, with a receiving device, a set of agreed-in-principle terms; converting, with at least one contract processor associated with the at least one first receiving device, the set of agreed-in-principle terms to smart contract code; wherein the smart contract comprises: at least one wallet address, at least one function, at least one method governing execution, and at least one method surviving execution.

In a configuration, receiving a set of agreed-in-principle terms comprises receiving the set of agreed-in-principle terms from one or more of an internal source, a network processor on the same network, from a payment network, and from a member of a payment network.

In a configuration, the smart contract further comprises metadata.

In a configuration, the method further comprises receiving approval of a buyer and a seller to the smart contract.

In a configuration, the method further comprises compiling the smart contract.

In a configuration, the method further comprises deploying the smart contract on a blockchain.

In a configuration, the blockchain is a public blockchain.

In a configuration, the method further comprises communicating one or more of information about the smart contract, information about an item being transferred, a categorization, information about a buyer associated with the smart contract, information about a seller associated with the smart contract and information about the agreed-in-principle terms of the smart contract to a/the payment network and/or to at least one member of the payment network.

In a configuration, the communicating step allows the payment network and/or member of the payment network to apply a merchant category code or a transaction type indicator to the transaction other than quasi-cash or digital goods.

In a configuration, the at least one method surviving execution comprises a temporary method which persists for a time period.

In a configuration, the time period is absolute or relative to a date associated with the smart contract.

In a configuration, the temporary method comprises one or more of a holding period, a dispute call, a warranty, a return policy, an insurance requirement, an insurance policy, a tax obligation, a lien on the item, and a dependency to execute at least one other contract within a follow-on time period.

In a configuration, the follow-on time period is predetermined or relative to a date associated with the smart contract.

In a configuration, the at least one method surviving execution comprises a non-temporary method.

In a configuration, the non-temporary method comprises one or more of a permanent record of ownership of a/the at least one NFT, a lien on the item, and an insurance policy.

In a configuration, the method surviving execution comprises an override provision.

In a configuration, the at least one method governing execution comprises one or more of a required value to be achieved by state data, an on-chain signature, and a timelock key.

In a configuration, the required value to be achieved by state data indicates a/the settlement guarantee or confirmation by a/the payment network and/or by at least one member of the payment network.

In a configuration, the required value to be achieved by state data is one or more of authorized, approved, authenticated, confirmed, cleared, and settled.

In a configuration, the method further comprises receiving and/or creating at least one transaction confirmation data element.

In a configuration, the transaction confirmation data element comprises one or more address, topics, data, blockNumber, timestamp, gasPrice, gasUsed, logIndex, transactionHash, and/or transactionIndex.

In a configuration, the method further comprises performing confirmatory processing to validate successful delivery of the NFT.

In a configuration, performing confirmatory processing to validate successful delivery of the NFT comprises performing a getOwnersForToken function, wherein the getOwnersForToken function returns a return wallet address.

In a configuration, performing confirmatory processing to validate successful delivery of the NFT further comprises determining the NFT has been successfully delivered if the return wallet address matches the account and/or wallet accessible to the buyer.

In a configuration, the method further comprises communicating the at least one transaction confirmation data element to a/the payment network, and/or a/the member of the payment network.

In a configuration, communicating the at least one transaction confirmation data element is performed after confirmatory processing to validate successful delivery of the NFT.

In a configuration, communicating the at least one transaction confirmation data comprises formatting the at least one transaction confirmation data as a chargeback rebuttal data feed.

In a configuration, the method further comprises: displaying, via a display device, at least one option for in-principle terms; enabling a/the buyer and/or a/the seller to make at least one input via a user input mechanism; and based on the at least one input, further displaying the set of agreed-in-principle terms.

In a configuration, the smart contract is amendable after execution upon approval of the buyer and seller to the amendment.

In another aspect, the disclosure broadly comprises a system for creating a smart contract for an off-chain payment transaction and an on-chain order fulfilment comprising: at least one first receiving device configured to receive a set of agreed-in-principle terms; at least one contract processor associated with the at least one first receiving device and configured to convert the set of agreed-in-principle terms to smart contract code; wherein the smart contract comprises: at least one wallet address, at least one function, at least one method governing execution, and at least one method surviving execution.

In a configuration, the receiving device is configured to receive the set of agreed-in-principle terms from one or more of an internal source, a network processor on the same network, from a payment network, and from a member of a payment network.

In a configuration, the smart contract further comprises metadata.

In a configuration, the at least one receiving device or at least one second receiving device is configured to receive approval of a buyer and a seller to the smart contract.

In a configuration, the at least one contract processor is configured to compile the smart contract.

In a configuration, the at least one contract processor is configured to deploy the smart contract on a blockchain.

In a configuration, the blockchain is a public blockchain.

In a configuration, the system further comprises a communication processor configured to communicate one or more of information about the smart contract, information about an item being transferred, a categorization, information about a buyer associated with the smart contract, information about a seller associated with the smart contract and information about the agreed-in-principle terms of the smart contract to a/the payment network and/or to at least one member of the payment network.

In a configuration, the at least one contract processor and the communication processor are: the same processor, different processors networked together, or different processors not networked together.

In a configuration, the communication allows the payment network and/or member of the payment network to apply a merchant category code or a transaction type indicator to the transaction other than quasi-cash or digital goods.

In a configuration, the at least one method surviving execution comprises a temporary method which persists for a time period.

In a configuration, the time period is absolute or relative to a date associated with the smart contract.

In a configuration, the temporary method comprises one or more of a holding period, a dispute call, a warranty, a return policy, an insurance requirement, an insurance policy, a tax obligation, a lien on the item, and a dependency to execute at least one other contract within a follow-on time period.

In a configuration, the follow-on time period is predetermined or relative to a date associated with the smart contract.

In a configuration, the at least one method surviving execution comprises a non-temporary method.

In a configuration, the non-temporary method comprises one or more of a permanent record of ownership of a/the at least one NFT, a lien on the item, and an insurance policy.

In a configuration, the method surviving execution comprises an override provision.

In a configuration, the at least one method governing execution comprises one or more of a required value to be achieved by state data, an on-chain signature, and a timelock key.

In a configuration, the required value to be achieved by state data indicates a/the settlement guarantee or confirmation by a/the payment network and/or by at least one member of the payment network.

In a configuration, the required value to be achieved by state data is one or more of authorized, approved, authenticated, confirmed, cleared, and settled.

In a configuration, the at least one receiving device is configured to receive and/or the at least one contract processor configured to create an at least one transaction confirmation data element.

In a configuration, the transaction confirmation data element comprises one or more address, topics, data, blockNumber, timestamp, gasPrice, gasUsed, logIndex, transactionHash, and/or transactionIndex.

In a configuration, the at least one contract processor is configured to perform confirmatory processing to validate successful delivery of the NFT.

In a configuration, the at least one contract processor configured to perform confirmatory processing further comprises the at least one contract processor configured to perform a getOwnersForToken function, further wherein the getOwnersForToken function returns a return wallet address.

In a configuration, the at least one contract processor configured to perform confirmatory processing further comprises the at least one contract processor further configured to make a determination that the NFT has been successfully delivered if the return wallet address matches the account and/or wallet accessible to the buyer.

In a configuration, the communication processor is configured to communicate the at least one transaction confirmation data element to a/the payment network, and/or a/the member of the payment network.

In a configuration, the communication processor is configured to communicate the at least one transaction confirmation data element after the contract processor made the determination of successful delivery.

In a configuration, the communication processor is configured to format the at least one transaction confirmation data as a chargeback rebuttal data feed.

In a configuration, the system further comprises: at least one display device configured to display at least one option for in-principle terms; at least one user input mechanism configured to enable a/the buyer and/or a/the seller to make at least one input; and based on the at least one input, further displaying the set of agreed-in-principle terms.

In a configuration, the smart contract is amendable after execution upon approval of the buyer and seller to the amendment.

Any aspect of this disclosure above may further comprise any one or more aspects or features mentioned in respect of any one or more of the other aspects, or wherein any aspect of the storage, transmission, processing, display, and/or rendering of any data (e.g., extracted and/or generated data) or metadata (e.g., extracted and/or generated metadata) and/or any aspect of the related system architecture may have any one or more of the features mentioned in respect of any other aspect described above, in any combination.

It is an object of the disclosure to improve on the processing of transactions that utilize fiat currencies as consideration for the transfer of non-currency blockchain assets (such as non-fungible or semi-fungible tokens) on public blockchains.

Additionally, It is an object of the disclosure to provide an efficient mechanism to match an off-chain fiat payment event (e.g., a credit/debit/prepaid card authorized via a card network (or an “on-us” issuer/acquirer) with on-chain order fulfillment (irrevocable transfer of title to buyer in a public blockchain environment).

It is further an object of the disclosure to provide an efficient mechanism to protect a seller or service provider against chargeback risk, should the order be disputed after having already been immutably fulfilled on a blockchain.

It is also an object of the disclosure to provide for an efficient mechanism to enable multiple parties, such as buyers alongside lenders, to jointly purchase with fiat certain goods, services, rights, titles, and/or licenses that may be held in blockchain wallet(s), in such a way that may codify the parties' shared interest in an asset (such as a primary lien).

It is an object of the disclosure to allow consumers and merchants to benefit from the use of traditional payment networks and payment systems in combination with blockchain non-fungible tokens, which are or represent assets, without any reliance on cryptocurrency or the burden of a third party service to convert fiat into cryptocurrency.

### BRIEF DESCRIPTION OF THE DRAWINGS

These and other features, aspects, and advantages of the present disclosure are described with reference to the drawings of certain embodiments, which are intended to schematically illustrate certain embodiments and not to limit the disclosure.

FIG. 1 illustrates a current high-level system architecture for procuring cryptocurrency to act as consideration for the execution of a blockchain contract.

FIG. 2 illustrates another current high level system architecture for a third-party service (NFT Direct service provider) collecting fiat funds to execute a blockchain contract for the benefit of a buyer.

FIG. 3 illustrates an embodiment of a novel and inventive high-level system architecture and method for receiving and processing transaction messages to associate a fiat payment to an on-chain order fulfilment.

FIG. 4 illustrates an embodiment of a novel and inventive system and method to create the terms of and deploy smart contracts.

FIG. 5 illustrates an embodiment of a novel and inventive system and method to receive, process and convey off-chain transaction messages for reference by on-chain tokens and/or smart contracts.

FIG. 6 illustrates an embodiment of a novel and inventive method and system to self-execute a smart contract.

FIG. 7 illustrates an embodiment of a novel and inventive method and system to report on-chain order fulfilment.

FIG. 8 illustrates an embodiment of a novel and inventive method and system architecture to address post-transaction dispute-related transaction messages.

FIG. 9 illustrates an embodiment of a novel and inventive method and system architecture for receiving and processing transaction messages to associate a fiat payments from two or more payers to an on-chain order fulfilment.

FIG. 10 is a block diagram illustrating the processor or processing server of the systems for payment transactions disclosed herein.

FIG. 11 is a block diagram illustrating a computer system architecture in accordance with exemplary embodiments.

FIG. 12 is a state diagram illustrating the effect of trigger conditions, deployed via code on a blockchain, to automatically execute on-chain code based on the state of off-chain payments data. FIG. 12 illustrates the fulfillment of an order and the provision of fulfilment data for efficient and secure querying by payment network participants.

FIG. 13 is a state diagram illustrating the effect of trigger conditions, deployed via code on a blockchain, to automatically execute on-chain code based on the state of off-chain payments data. FIG. 13 illustrates the reversal of an order and the provision of reversal data for efficient and secure querying by payment network participants.

### DETAILED DESCRIPTION OF THE INVENTION

### Glossary of Terms

Smart contract: a programmatic contract with the terms of the agreement directly written into code, that executes when the preset conditions by the involved parties are met. A smart contract may be complied, converted into bytecode, and stored on a blockchain. It may have an address assigned, such as a ContractID. Smart contracts may govern wallet holder permissions, such as in the case of a smart contract wallet (such as in ERC-4337 and EIP-7702). A smart contract may atomically and automatically execute based on pre-defined trigger conditions or states.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, loans, etc. Payment networks may be configured to perform transactions via cash-substitutes, which may include payment cards, letters of credit, checks, transaction accounts, digital wallets, etc. Use of the term “payment network” herein may refer to both the payment network as an entity, and the physical payment network, such as the equipment, hardware, and software comprising the payment network. Some payment networks may use architectures such as single message (for example, MasterCard® Debit Switch), dual message (for example, MasterCard® Global Clearing Management System using the Integrated Product Messages (IPM) format), China switch, or other architectures. Examples of networks or systems configured to perform as payment networks include, without limitation:
Those operated by MasterCard®, VISA®, Discover®, American Express®, PayPal®
Real time payments systems, such as those operated as Faster Payments UK, The Clearing House® RTP, FedNow®, SEPA Instant Transfer
Open banking protocols, such as those overseen by the UK Open Banking Implementation Entity, Revised Payment Services Directive (PSD2), and US Consumer Financial Protection Bureau (CFPB) e.g., Rule 1033.
Peer-to-peer platforms, staged digital wallets, messaging applications, marketplaces, embedded finance solutions, person-to-merchant platforms, B2B platforms, and/or ecommerce platforms that can convey payments, such as PayPal®, Venmo®, Zelle®, CashApp®, SamsungPay®, GooglePay®, AliPay®, Square®, Twitter®
Global payment messaging solutions that transmit payments or messages about payments, such as those operated by SWIFT®, Ripple®, Transferwise®, or Airwallex®

Fiat Account—A financial account that may be used to fund a transaction, such as a checking account, savings account, credit account, virtual payment account, digital wallet account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Blockchain—A decentralized, and distributed public or private ledger of transactions. One or more computing devices may comprise a blockchain network, which may be configured to process and record transactions as part of a block in the blockchain. Once a block is completed, the block is added to the blockchain and the transaction record thereby is updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured such as a metadata pertaining to the provenance, ownership, title, or custody of an asset, and/or confirming the conveyance of certain services.

Token: a representation of any item or items on a blockchain, which may include fungible assets (such as cryptocurrency), and/or non-fungible assets (such as goods, services, rights, titles, licenses). These assets may be virtual or non-virtual. Tokens may also represent smart contracts that perform certain functions on a blockchain. Tokens may be dynamic (i.e., dNFT), encoded with smart contract logic that enables token(s) to automatically change metadata based on external conditions; retaining tokenID while updating aspects of metadata, even if such metadata post-dates the minting of a dNFT. Tokens may also govern walletholder permissions, such as in the case of a token-bound account. Tokens may represent real world assets (RWA) such as property, real property, securities (including USA 40 Act securities), claims, rights, titles, licenses, memberships, subscriptions, or any other store of value, temporary or permanent. Tokens may have utility, which may include the ability to be utilized as collateral, security, yield generation, or a settlement mechanism, on or off a blockchain. It should be appreciated by one of skill in the art that non-fungible tokens, semi-fungible tokens, and token-based accounts utilize standards such as ERC-721, ERC-721A, ERC-1155, ERC-6551, ERC-998, ERC-777, and/or any other token standard configured for a blockchain network that includes a virtual machine for executing contract bytecode on its blockchain. Each token standard may have a different set of requirements or features that the token must have to be considered a token that implements that standard and that can be used by smart contracts or applications that are also generated according to that token standard. These tokens may represent smart contracts, and thus be able to perform certain actions based on a set of parameters or inputs.

On-Chain Wallet (Wallet): a digital interface that allows users to store, manage, utilize, and exchange Tokens. Wallets may include software wallets and hardware wallets. Wallets may be custodial, non-custodial, or semi-custodial in nature, utilizing standards such as multi-party computation (MPC) and dedicated key management system (DKMS). Wallets may be multi-signature. Wallets may include Externally Owned Accounts (EOAs) and Account Abstraction (AA) wallets, such as smart contract wallets that include functionalities such as the ability to crate batch transactions, session keys, modifiable signers, gas relay (in ERC-20 or stablecoins), and create accounts without a seed phrase. Wallets, as used herein, include those that may already be held or accessible by a buyer or seller, as well as those that are created “on-demand” via a wallet factory and made available/accessible to a buyer or seller (including via an existing buyer/seller wallet). It should be appreciated by one of skill in the art that a wallet may be accessible by other wallets under certain conditions, such as, for example, where an EOA wallet is on the signatory list (or is the only signatory) for a deployed smart contract wallet. It should be appreciated by one of skill in the art that wallets may utilize various standards such as ERC-4337, EIP-7702, and/or any other standard configured for a blockchain network that includes a virtual machine for executing contract bytecode on its blockchain. As used herein, a wallet described as being “held by” an entity includes a wallet that is accessible by that entity. Likewise, as used herein, a wallet described as being “owned” by an entity includes a wallet that is accessible by that entity.

Transaction Message: a message sent between, within, and/or amongst any parties involved in a payment that conveys the state or status of a payment and/or payment request. Transaction messages include without limitation those utilized by or between any of the following parties: buyer, seller, payment network, issuer, acquirer, payment gateway, merchant, master merchant, sub-merchant, payment service provider, processor, payment facilitator, ecommerce gateway, ecommerce marketplace, ecommerce checkout provider, cloud infrastructure provider, terminal provider, loyalty provider, card linked offer provider, escrow service, reseller, financial institution, trustee, BIN sponsor, card network member, AISP, PISP, TSP, ASPSP, payments infrastructure provider, payments regulator, and/or any other entity that receives or is able to observe information about a payment. It should be appreciated that a transaction message may be a single transaction message, or it may include more than one transaction messages (for example, as in the case of a dual message payments network). It should be appreciated that transaction message(s) may reflect a one-time payment or a recurring payment.

Transaction messages may include for example, and without limitation, one or more of Payment messages, Authentication messages, Card Linked Offer (CLO) messages, Open Banking messages, Real time payment messages, Peer-to-peer or staged digital wallet messages, Cross-border payment messages, Electronic Funds Transfer (EFT) messages, and/or any suitable messages derived therefrom (in any format).

Payment messages: are messages which may be shared amongst payment networks and its participants and/or their representatives. Payment messages may be formatted based on one or more standards for the governance thereof, which may include without limitation the International Organization for Standardization's ISO 8583:2023 or ISO 20022:2013 standards.

Payment messages may confer, for example, request(s) and/or response(s) related to a given transaction or set thereof. Payment messages may convey the state or status of a transaction (including, for example, whether a transaction has been authorized, cleared, or settled). Payment messages may take any format. Payment messages may include a message type indicator (MTI) which designates version, class, function, and/or origin, such as those within ISO 8583:2023. Payment messages may include any version, class, function, and/or origin. Such message may include those utilized by a payment network and/or its members or their representatives to communicate a settlement guarantee with respect to a transaction. The generation and use of numeric response codes will be apparent to persons having skill in the relevant art.

For example, payment messages may include any message(s) of any class, such as authorization message (x1xx), financial message (x2xx), file action message (x3xx), reversal and chargeback message (x4xx), reconciliation message (x5xx), administrative message (x6xx), fee collection message (x7xx), network management message (x8xx), and/or any other class, such as those reserved by ISO (such as x0xx, x9xx).

For example, payment messages may include any message(s) of any function, such as request (xx0x), request response (xx1x), advice (xx2x), advice response (xx3x), notification (xx4x), notification acknowledgement (xx5x), instruction (xx6x), instruction acknowledgement (xx7x), and/or any other function, such as those reserved for ISO (such as xx8x, xx9x).

For example, payment messages may include any message(s) of any origin, indicating the message source, such as acquirer (xxx0), acquirer repeat (xxx1), issuer (xxx2), issuer repeat (xxx3), other (xxx4), and/or any other origin, such as those reserved by ISO (such as xxx60, xxx6, xxx41).

For example, combining the above and for the avoidance of doubt, payment messages may include any message(s) such as authorization request (1100), response (1110), advice (1120), repeat (1121), or advice response (1130), sale (1200), completion (1210), refunds (1220), or force (1230).

Alternatively, or additionally, payment messages may be formatted in any other standard, such as the ISO 20022:2013 standard. This may include, for example, MX messages. This may include, for example, Payment Initiation message schema pain.001.001.11 or pain.002.001.13, or any other such message. This may include messages of any ISO 20022 message set, such as without limitation acmt, admi, auth, caaa, caad, caam, cafc, cafm, cafr, cain, camt, canm, casp, casr, catm, catp, colr, fxtr, head, pacs, pain, reda, remt, secl, seev, semt, sese, setr, tsin, tsmt, and/or tsrv.

Alternatively, or additionally, payment messages may also utilize any other standard or format, such as adaptations used by open banking protocols (such as OBIE UK), real time payment networks (such as FedNow), UK Faster Payment Scheme, SWIFT (MT messages), and/or any other such message type that may be utilized to convey confirmation of a payment.

Authentication messages, including those that convey the result of a 3DS:2001 (or 3DS2.0:2016) Authentication attempt, or the absence thereof. This includes, for example, Authentication Response Codes that are blank or alphanumerical, signifying the presence or absence of a “liability shift” and the reasoning (i.e., error codes) for such shift or absence thereof. This includes, for example, without limitation, authentication result codes that are returned by Visa® for the Verified by Visa™ service or MasterCard® for the Mastercard SecureCode™ service, or Discover® for the ProtectBuy™ service. Such messages may be relevant to confirm that the seller and/or seller's acquirer no longer hold certain types of dispute risk (such as some forms of chargeback).

Card Linked Offer (CLO) messages, including those commercially available from or on behalf of payment networks and/or its members. This may take the form of programs such as Visa Offers Platform™ or Mastercard Personalized Card Linked Offers™. This may be available to service 308 via APIs, webhooks, and/or other services of or on behalf of payment networks 310. Such programs will be apparent to persons having skill in the relevant art. Such messages may include summarized data about a given transaction, upon consent of interested parties.

Open Banking messages, including those that may be shared amongst participants in any open banking regime such as the Revised Payment Services Directive (PSD2), Consumer Data Right Australia (CDR), Consumer Data Right New Zealand, Monetary Authority of Singapore, or regimes defined by the United States Consumer Financial Protection Bureau (including those proposed or established under section 1033 of the Consumer Financial Protection Act of 2010). This may include any messages accessible to or relayed from any of an Account Information Service Provider (AISP), Payment Initiation Service Provider (PISP), Technical Service Provider (TSP), Account Servicing Payment Service Providers (ASPSP), data provider, developer interface, consumer interface, third party interface, data aggregator, or any intermediary thereto. Data conveyed via these messages may include details of individual transactions, account balances, routing and account numbers, terms and conditions, upcoming bill information, and/or basic account verification details. Open banking messages may include those that utilize technical standards such as those prescribed by the United Kingdom Open Banking Implementation Entity (OBIE), XS2A (e.g., Germany), STET (e.g., France), Consumer Data Right Data Standards Body (Australia), and/or PolishAPI standards. Open banking messages may include those that utilize any “qualified industry standard”, including those that may be set forth under the United States Consumer Financial Protection Act of 2010 (CFPA) section 1033. This may include qualified industry standard applicable to any third party, authorized third party, consumer, or data aggregator, such as those which may be proposed in section 1033.131. This may include any qualified industry standard that may serve as an indicia of compliance with and/or carry out the objective of any rule(s) set forth in CFPA, for any party.

Real time payment messages, including messages corresponding to or conveyed via any real time payment network such as those operating under the Faster Payments Network™ (UK), FedNow® (US), The Clearing House® RTP (US), PromptPay™ (Thailand), Unified Payments Interface™ (India), SEPA Credit Transfer Instant Payments (EU), Faster Payments System (Hong Kong), New Payments Platform (Australia), FAST (Singapore), or other similar systems globally. Alternatively, this may include messages accessible to or relayed from any participant of a real time payment network, such as a Faster Payment System Participant (typically a bank).

Peer-to-peer or staged digital wallet messages, including message types utilized by platforms, application(s), staged digital wallet, pass through digital wallet, messaging application, ecommerce platform, or marketplace that enables one party to pay another. These may utilize data formats such as REST, JSON, GraphQL, SQL, or OpenAPI. These may utilize web services interfaces including public or private API endpoints that will be apparent to persons having skill in the relevant art.

Cross-border payment messages, including those for institutional, corporate, or correspondent banking purposes, which may be utilized by a platform, service provider, messaging standard, or money transmitter that enables one party to pay another, including internationally. This may include messaging services (e.g., SWIFT®) that utilize standards such as ISO 20022 or SWIFT Message Type (e.g., MT, inclusive of MT1xx used for payments). Alternatively, this may include blockchain-based messaging services such as Ripple® that utilize publicly-observable message transmission methods to convey payment Alternatively, this may include cross-border money transmitters or electronic funds transfer (EFT) services such as Western Union®, Airwallex®, or Transferwise®, utilizing internal messaging services to convey payment including institutional movement of funds;

Electronic Funds Transfer (EFT) messages, including those utilized by an EFT payments network, such as the Bankers' Automated Clearing System (BACS, run by Pay.UK®) in the UK, or Automated Clearing House Network (ACH, including FastACH, run by Nacha®). These may include messages, transactions, requests, and/or responses pertaining to the processing of payments. This may include messages in data formats such as ASCII, tradeID, and/or Standard18, using methods and systems that will be apparent to persons having skill in the relevant art. This may include messages in data formats such as FDX (Financial Data Exchange) or OFX (Open Financial Exchange, including without limitation OFX Banking Version 2.3 (October 2020) and Tax Extension Version 2021.0), which may provide a common standard or the secured and convenient access of permissioned consumer and business financial data. EFT messages may also include any messages or standards utilized amongst sub-merchants and/or master merchants associated with a payment facilitator, bank-as-a-service (BaaS) provider, or any other shared service providers. EFT messages may also include any messages or standards utilized amongst financial institutions and/or master accounts, such as those utilized by Zelle® or The Clearing House® (TCH) within a federal account.

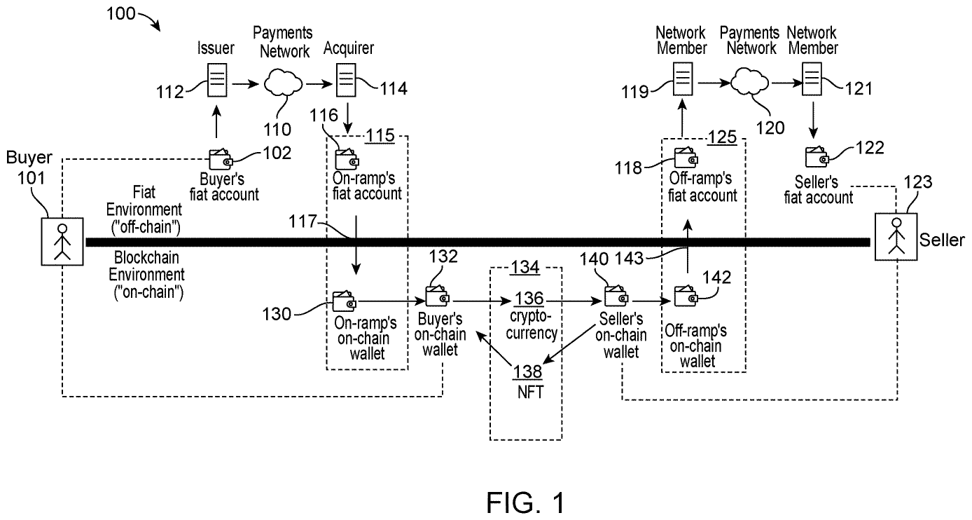

FIG. 1 illustrates an example current system 100 for securing cryptocurrency to execute a blockchain smart contract 134 resulting in the transfer of one or many digital goods, services, rights, claims, or titles which may be represented by one or many NFTs 138 to a buyer's on-chain wallet 132.

The buyer's on-chain wallet 132 must possess cryptocurrency 136 to procure at least one NFT 138 from seller's on-chain wallet 140. In order for buyer's on-chain wallet 132 to procure cryptocurrency 136, the buyer utilizes a series of intermediaries. These intermediaries, e.g. 110, 112, 114, 116, 130, enable to buyer to convert fiat currency (e.g., USD held in buyer's fiat account 102) to cryptocurrency (e.g., ETH held in buyer's on-chain wallet 132).

Firstly, the buyer using buyer's fiat account 102 enters into a purchase agreement with on-ramp 115 to pay fiat into on-ramp's fiat account 116. This may be done for example by entering credit or debit card details via an e-commerce gateway, point of sale terminal, payment processor, or payment service provider. On-ramp 115 may then become merchant of record with respect to a payment network transaction, receiving in fiat the net proceeds from the transaction into on-ramp's fiat account 116. The issuer 112, payments network 110, and acquirer 114 may be involved in processing this payment transaction in the conventional way using traditional payment rails (i.e. industry-standardized methods and systems that will be apparent to persons having skill in the relevant art). Alternatively, one or more of these entities may not be needed, e.g. in the case where the buyer 101/102 has a direct relationship with an on-ramp 115 (not shown), or where the payments network 110 has a direct relationship with the buyer 101/102 and/or on-ramp 115 (not shown).

Each of payments network 110 and acquirer 114 may charge a fee, which may occur via net settlement. The on-ramp 115 may additionally charge a fee to buyer's fiat account 102 in the form of a markup (for example, charging $107 for a $100 transfer of value). For example, the buyer may pay $107, of which the payment network 110 and acquirer 114 may collectively capture $3.21, remitting $103.79 to on-ramp's fiat account 116.

Secondly, upon receipt of message authorizing, confirming, and/or ensuring payment has been or will be made into on-ramp's fiat account 116, on-ramp 115 may send instruction to its on-chain wallet 130, which may have been previously funded and held on a certain blockchain, to transfer value in the form of cryptocurrency, which may be cryptocurrency 136, to buyer's on-chain wallet 132. On-ramp 115 will set the rate of exchange 117 from fiat to cryptocurrency (for example, by delivering $97 worth of $ETH in exchange for $103.79 of fiat as received). On-ramp 116 may price-compete with any other on-ramp 116 on the basis of this exchange rate.

This step introduces a risk parameter on the buyer 101, whereby the buyer individually relies on the third party on-ramp to follow through on the on-chain transfer of cryptocurrency. This includes the on-ramp appropriately pricing the transaction, supporting the given protocol, and having access to the on-chain liquidity in the form of tokens required for order fulfilment—typically already held in on-ramp's on-chain wallet 130. Furthermore, the on-ramp may also rely on exchanges (centralized or decentralized), bridges, market makers, or their own pools of liquidity—as well as certain other services such as oracles for price feeds and/or API-enabled wallet providers (which may be hosted or unhosted).

This step also introduces a risk parameter on the on-ramp 115 whereby on-ramp 115 irrevocably and immutable delivers fungible cryptocurrency to buyer's on-chain wallet 132. On-ramp 115 then becomes subject to possible claims of fraud, technical error, etc., wherein the buyer 101 files a dispute (such as a chargeback) to issuer 112 or other intermediary. This begins a dispute resolution process typically run by payment network 110 or other intermediary, often with a financial penalty borne by on-ramp 115.

Thirdly, once buyer's on-chain wallet 132 possesses cryptocurrency 136, that buyer's on-chain wallet 132 can execute a blockchain smart contract 134 with counterparty seller's on-chain wallet 140. When executed, this smart contract 134 can simultaneously (or “atomically”) transfer cryptocurrency 136 (e.g., an ERC-20 fungible token) from buyer to seller, and at least one NFT 138 (e.g., an ERC-721 non-fungible token or an ERC-1155 semi-fungible token) from seller to buyer.

Fourthly, upon receipt of cryptocurrency 136, seller's on-chain wallet 140 may seek to convert cryptocurrency 136 to fiat. For example, seller's on-chain wallet 140 may hold $96.50 worth of $ETH (or whichever cryptocurrency 136 was utilized as consideration for NFT 138), net of transaction fees (“gas,” for example as $0.50 worth of $ETH and borne by seller in this example, noting this may have been paid by either party according to the smart contract 134). To transfer cryptocurrency 136 to fiat, seller's on-chain wallet 140 may transfer cryptocurrency 136 to yet another service provider: an off-ramp 125. In this example, seller's on-chain wallet 140 transfers cryptocurrency 136 to off-ramp's on-chain wallet 142, again paying transaction fees (“gas”, for example as $0.50 worth of $ETH and borne by seller).

Fifthly, upon receipt of cryptocurrency 136 (now $96 worth of $ETH) into off-ramp's on-chain wallet 142, off-ramp 125 may instruct off-ramp's fiat account 118 to transfer a certain amount of fiat currency to seller's fiat account 122. Like on-ramp 115, off-ramp 125 will set exchange rate 143 from cryptocurrency to fiat (for example, by delivering $94 in exchange for $96 worth of $ETH). Off-ramp 125 may price-compete any other off-ramp 125 on the basis of this exchange rate 143.

Finally, fiat may be transferred from off-ramp 118 to seller fiat account 122 via any conventional method such as account-to-account, ACH, digital wallet, original credit transfer or other commonly-utilized methods and systems that will be apparent to persons having skill in the relevant art. This may include via network members 119 and 121, who may be issuers and/or acquirers that participate in payments network 120. Alternatively, one or more of these entities may not be needed, e.g. in the case where the seller 122/123 has a direct relationship with an off-ramp 125, or where the payments network 120 has a direct relationship with the seller 122/123 and/or off-ramp 125.

In this manner, a buyer 101 converts fiat to cryptocurrency 136 utilizing multiple intermediaries, and buyer 101 then utilizes the resultant cryptocurrency 136 as consideration for at least one NFT 138. Upon receipt of cryptocurrency 136, seller 123 utilizes multiple intermediaries to convert cryptocurrency 136 back into fiat.

Indeed, in the above example, buyer's fiat account 102 spent $107 to procure NFT 138, with the seller's fiat account 122 receiving only $94 in fiat, and the $13 balance going to intermediaries in the transaction.

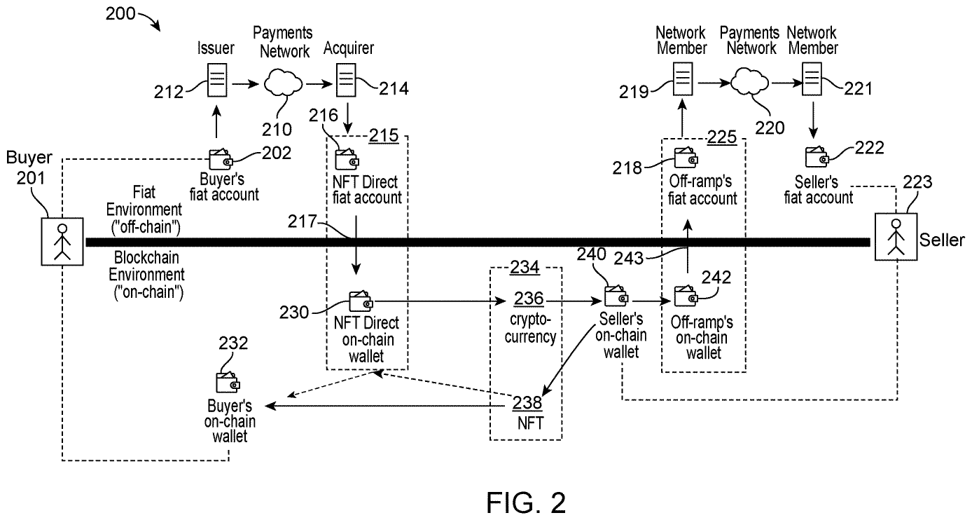

FIG. 2 illustrates another similar example of a current system 200 for a third-party service (NFT direct service provider 215) collecting fiat funds to execute a blockchain smart contract 234 on behalf of a buyer 201, resulting in the transfer of one or many digital goods, services, rights, claims, or titles, which may be represented by one or more NFTs 238, directly or indirectly to a buyer's on-chain wallet.

It should be appreciated that similar reference numerals between figures represent similar components of the systems and methods recited herein, with any differences noted with respect to each individual figure or reference numeral.

Unlike FIG. 1, the buyer need not possess cryptocurrency 236 to execute the transaction. Rather, the NFT direct service provider 215 utilizes its own cryptocurrency 236 in the NFT direct's on-chain wallet 230 to purchase the at least one NFT 238 on behalf of the buyer.

Firstly, the buyer 201 using buyer's fiat account 202 enters into a purchase agreement with NFT direct service provider 215 to pay fiat into NFT direct's fiat account 216. This may be done for example by entering credit or debit card details via an e-commerce gateway, point of sale terminal, payment processor, or payment service provider. NFT direct service provider 215 may then become merchant of record with respect to a payment network transaction, receiving in fiat the net proceeds from a purchase transaction. The issuer 212, payments network 210, and acquirer 214 may be configured to process payment transactions using traditional payment rails (i.e. industry-standardized methods and systems that will be apparent to persons having skill in the relevant art). Alternatively, one or more of these entities may not be needed, e.g. in the case where the buyer 201/202 has a direct relationship with NFT direct service provider 215 (not shown), or where the payments network 210 has a direct relationship with the buyer 201/202 and/or NFT direct service provider 215 (not shown).

Unlike FIG. 1, this transaction may utilize conventional merchant category codes, such as those defined by ISO (International Organization for Standardization), consistent with the purchase of goods (such as 7999, 5999, 5815), as opposed to merchant category codes consistent with a quasi-cash or cash-out transaction (such as 6051), which may commonly be used in FIG. 1. This has the effect to increase approval rates from issuing banks (i.e. 112/212), by signifying the sale of an item (e.g., a digital good such as an ERC-721 NFT or an ERC-1155 semi-fungible token) rather than a quasi-cash instrument (e.g., a fungible asset such as an ERC-20 token).

In this regard, the NFT direct service provider 215 may purchase an item using funds from its own on-chain wallet 230, acting on behalf of the buyer, and transmitting NFT 238 from seller on-chain wallet 240 to buyer on-chain wallet 232 atomically via smart contract 234. Alternatively, NFT 238 may be intermediately transferred from seller on-chain wallet 240 to NFT direct on-chain wallet 230, or any other wallet created by NFT direct service provider 215 and subsequently transferred to buyer's on-chain wallet 260.

Like FIG. 1, this step introduces a risk parameter on the NFT direct service provider 215, whereby the service provider 215 irrevocably and immutably makes delivery of a non-fungible token to buyer's on-chain wallet 232. Operating as merchant of record, the NFT direct service provider 215 becomes subject to possible claims of fraud, technical error, etc., wherein the buyer via buyer's fiat account 202 files a dispute (such as a chargeback) to issuer 212 or other intermediary. This begins a dispute resolution process typically run by payment network 110 or other intermediary, often with a financial penalty borne by on-ramp 115.

Like FIG. 1, each of payment network 210 and acquirer 214 may charge a fee via net settlement. NFT direct service provider 215 will additionally charge a fee to buyer's fiat account 202 in the form of a markup. This economic flow mimics the one illustrated in FIG. 100.

Upon receipt of message authorizing, confirming, and/or ensuring payment has been or will be made into NFT direct's fiat account 216, NFT direct service provider 215 may send instruction to its on-chain wallet 230, previously funded and held on a blockchain, to transfer value in the form of cryptocurrency 236 to seller's on-chain wallet 232. NFT Direct service provider 215 will set the rate of exchange rate 217 from fiat to cryptocurrency (for example, by delivering $97 worth of $ETH in exchange for $103.79 of fiat as received). NFT Direct service provider 215 may also rely on exchanges (centralized or decentralized), bridges, market makers, or their own pools of liquidity—as well as certain other services such as oracles for price feeds and/or API-enabled wallet providers (which may be hosted or unhosted).

Once NFT direct service provider 215 instructs its on-chain account 230 to transfer value to seller's on-chain wallet 240, this can execute smart contract 234 with counterparty seller's on-chain wallet 240, in the form of a signature.

When executed, this smart contract 234 can simultaneously (or “atomically”) transfer cryptocurrency 236 (e.g., an ERC-20 fungible token) from buyer's representative (i.e. NFT direct service provider 215) to seller, and at least one NFT 238 (e.g., an ERC-721 non-fungible token or an ERC-1155 semi-fungible token) from seller to buyer or buyer's representative. Cryptocurrency 236 will flow from NFT Direct's on-chain wallet 230 to seller's on-chain wallet 240.

NFT 238 will flow from seller's on-chain wallet 240 or other related wallet to either of buyer's on-chain wallet 260 directly, or indirectly via a wallet held or accessible by NFT direct service provider 215, which may be NFT direct's on-chain wallet 230 or another wallet set up for the purposes of intermediate custody.

Like FIG. 1, upon receipt of cryptocurrency 236, seller's on-chain wallet 240 may seek to convert cryptocurrency 236 to fiat. For example, seller's on-chain wallet 240 may hold $96.50 worth of $ETH (or whichever cryptocurrency 236 was utilized as consideration for NFT 238), net of transaction fees (“gas,” for example as $0.50 worth of $ETH and borne by seller in this example, noting this may have been paid by either party according to the smart contract 234). To transfer cryptocurrency 236 to fiat, seller's on-chain wallet 240 may transfer cryptocurrency 236 to yet another service provider: an off-ramp 225. In this example, seller's on-chain wallet 240 transfers cryptocurrency 236 to off-ramp's on-chain wallet 242, again paying transaction fees (“gas”, for example as $0.50 worth of $ETH and borne by seller).

Like FIG. 1, upon receipt of cryptocurrency 236 (now $96 worth of $ETH) into off-ramp on-chain account 242, off ramp 225 may instruct off-ramp fiat account 218 to transfer a certain amount of fiat currency to seller's fiat account 222. Like NFT direct 215, the off-ramp service may set exchange rate 243 from cryptocurrency to fiat (for example, by delivering $94 in exchange for $96 worth of $ETH). Off-ramps may price-compete based on this exchange rate 243.

Finally, like FIG. 1, fiat may be transferred from off-ramp's fiat account 218 to seller's fiat account 222 via any conventional method such as account-to-account, ACH, digital wallet, original credit transfer or other commonly-utilized methods and systems that will be apparent to persons having skill in the relevant art. This may include via network members 219 and/or 221, who may be issuers and/or acquirers that participate in payments network 220. Alternatively, one or more of these entities may not be needed, e.g. in the case where the seller 222/223 has a direct relationship with an off-ramp 225, or where the payments network 220 has a direct relationship with the seller 222/223 and/or off-ramp 225.

In this manner, a buyer 201 makes a fiat payment from buyer's fiat account 202 to NFT direct's fiat account 216, who utilizes its own cryptocurrency 236 to purchase at least one NFT 238 from seller 240 for the benefit of buyer 201 and delivery into buyer's on-chain wallet 232. Upon receipt of cryptocurrency 236, seller's on-chain wallet 240 may utilize multiple intermediaries to convert cryptocurrency 236 back into fiat, for receipt into seller's fiat account seller 222.

Like FIG. 1, buyer's fiat account 202 spent $107 to procure at least one NFT 238, with the seller's fiat account 222 receiving only $94 in fiat currency; however, they did so without buyer 201/202 having to itself procure cryptocurrency (instead using an intermediary 215 who purchases the NFT 238 for the benefit of the buyer).

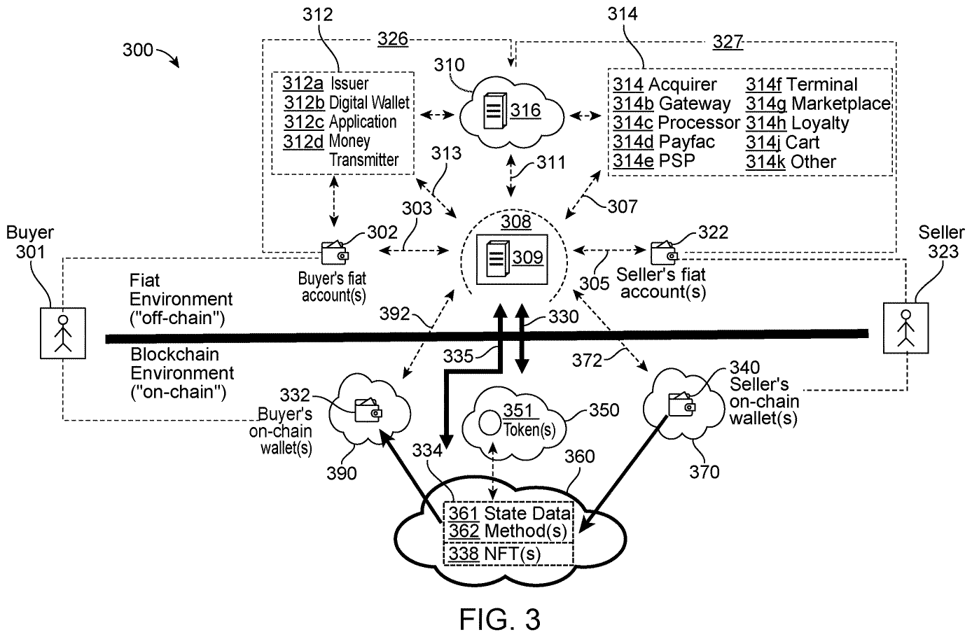

FIG. 3 illustrates an example of a new system 300 for receiving, processing, and efficiently conveying transaction messages (which may include authorization response messages and/or authentication result codes) to blockchain contracts, whilst embedding method(s) 362 that may for example durably protect seller against the risk of disputes.

In the system 300, a transaction occurs between the buyer 301 (represented by buyer's fiat account(s) 302 and buyer's on-chain wallet(s) 323) and the seller 323 (represented by seller's fiat account(s) 322 and seller's on-chain wallet(s) 340). As used herein, “buyer” may refer to a computing device and/or a consumer or business that is funding a payment transaction, and “seller” may refer to a computing device and/or a consumer or business that is receiving payment in a payment transaction. It should be appreciated that each of buyer and seller may have one or more fiat account(s) and on-chain wallet(s), and thus references to the singular should be read to include the plural or “at least one”, and vice-versa.

The system 300 may also include a payments network 310, which may include one or more computing devices. The payments network 310 may be configured to process payment transactions using traditional payment rails (i.e. industry-conventional methods and systems that will be apparent to persons having skill in the relevant art).

In the system 300, the payments network 310 may also include a processing server or network of servers 316. The processing server 316, discussed in more detail herein, may be configured to authorize transactions or transmit messages pertaining to the authorization of transactions.

Buyer's fiat account 302 may be associated with one or more buyer servicers 312. Buyer servicer 312, discussed in more detail herein, may be a computing system of a financial institution, such as an issuing bank, that issues one or more transaction accounts to the buyer 301. The transaction accounts may include one or more fiat currency transaction accounts. Buyer servicer 312 may include one or more of, for example, issuer 312a, digital wallet 312b, application 312c, money transmitter 312d, or other similar services that perform a payments function in relationship to buyer's fiat account 302. In some examples, buyer's fiat account 302 may omit buyer's servicer 312 to interact directly with payment network 310, as shown with arrow 326.

The seller's fiat account 322 may be associated with at least one seller servicer 314. Seller servicer 314, discussed in more detail herein, may be a computing system of a financial institution, such as an acquiring bank, that issues one or more transaction accounts to seller. The transaction accounts may include one or more fiat currency transaction accounts. Seller servicer 314 may include one or more of, for example, acquirer 314a, payment gateway 314b, processor 314c, payment facilitator 314d, payment service provider (PSP) 314e, point-of-sale (POS) terminal 314f, ecommerce marketplace 314g, loyalty provider 314h, virtual shopping cart provider 314j, or any other service(s) 314k that perform a payments function in relationship to seller's fiat account(s) 322. In some examples, seller's fiat account 322 may skip seller's servicer 314 to interact directly with payments network 310, as shown with arrow 327.

The seller servicer 314 may be the equivalent of the buyer servicer 312, but with respect to the seller's fiat account 322 rather than the buyer's fiat account 302. In some instances, the buyer servicer 312 (inclusive of issuer 312a) and the merchant servicer 314 (inclusive of acquirer 314a) may be the same financial institution. For example, the issuer 312a may provide both the buyer's fiat account 302 and the seller's fiat account 322.

The seller may be associated with central service 308. Central service 308 may also include a processing server 309. Central service 308 may be any entity, including without limitation buyer 301, seller 323, seller servicer 312, payments network 310, buyer servicer 314, cloud infrastructure provider (not shown), escrow service (not shown), reseller (not shown), oracle (not shown), or other entity (not shown) that receives or is able to observe information about a payment. It should be appreciated that central service 308 may be provided via an existing entity 112, 100, 114, 119, 120, 121, 115, 125, 212, 210, 214, 219, 220, 221, 215, 225, 312 and/or subparts, 310, 314 and/or subparts, or the like, as previously described, and that in an embodiment where this is the case, the method steps or messages between central service 308 and that entity which includes central service 308 would be internal messages or methods steps within that entity. It should further be appreciated that in some embodiments, the issuer (i.e. 112, 221, 312 and the like) and the acquirer 114, 214, 314, and the like) may be the same entity.

For example, the central service 308 may receive payment data from one or more sources such as:
via message path 303 from the buyer's fiat account 302, for example without limitation via a buyer's financial application, digital wallet, application, client, or service that accesses a buyer's systems or emails for confirmation messages;
via message path 313 from one or more of seller's servicer 312 for example without limitation via an issuer's banking application, API endpoints, or direct integration;
via message path 311 from payments network 310, which may include processor 316, for example without limitation via a card network's core systems, exposed endpoints, services such as card linked offers or other similar loyalty platforms;
via message path 307 from one or more of buyer's servicer 314, for example without limitation via a merchant's banking application, direct integration, API feed, terminal integration, gateway integration, processor integration, ecommerce cart status, checkout page, or other similar means;
via message path 305 from the seller's fiat account 322, upon receipt of payment message from any source, for example without limitation via a seller's financial application, digital wallet, application, client, or service that accesses a seller's systems or emails for confirmation messages.

The central service 308 may access and/or store transaction messages or metadata thereof on a web server or a decentralized storage solution, which may be publicly accessible by a smart contract on a public blockchain. Such data or metadata may be encrypted at the database level or transaction level. Such data or metadata may be summarized into generated metadata to provide confirmatory information or state data regarding transaction outcome in such a manner that does not relay sensitive data (such as credit card number) to a public blockchain. Such data may single-source (for example, via one of path 303, 311, 301, 319, 305), or be validated via a consensus mechanism whereby multiple paths must agree with a transaction status.

In some instances, buyer 301 and/or buyer's fiat account 302 may interact with buyer's servicer 312, central service 308, payments network 310, and/or seller's servicer 314 to execute a transaction. This may include performing an online checkout, adding to and/or purchasing goods via a virtual cart 314j, interacting with a physical point of sale terminal 314f, interacting with an ecommerce marketplace platform 314g, receiving or fulfilling a payment request via a digital wallet platform 312b, logging in to a proprietary platform 314k, and/or engaging in another similar experience 314k to effect a payment.

This interaction may result in certain transaction messages, such as authorization or authentication request(s), being sent to buyer's service(s) 312, including via payments network 310. In some instances, the payments network 310 and/or processing server 316 may receive the transaction message and may generate a subsequent transaction message.

The transaction message may include a plurality of data elements, which may be associated with specific usage based on one or more standards. For example, the data elements may include a destination address (e.g., associated with the seller's fiat account(s) 322), a merchant ID, and/or a merchant category code, among other data. The generation and use of destination addresses, merchant ID, and merchant category code will be apparent to persons having skill in the relevant art.

Additionally, the applicant has surprisingly found that “passing through” additional data about blockchain smart contract 334, including its underlying terms and characteristics, may advantageously increase transaction approval rates. For example, payments network 310 and/or buyer's servicer 312 may receive within a transaction message certain descriptor(s) or unique identifier(s) that characterize the intended transaction, (blockchain smart contract 334). These may be utilized by buyer's servicer 312 to assess a transaction for authorization, authentication, and/or approval, based on characterization not as quasi-cash (MCC: 6051) or digital goods (MCC: 5815) (either of which may be more likely to be declined), but rather as “pass through” data that reflects the true nature of the actual item(s) being transferred, which may be represented by at least one NFT 338 (e.g., an ERC-721 non-fungible token or an ERC-1155 semi-fungible token).

The additional pass-through data elements may include one or more of, for example, information about the blockchain smart contract 334, data about the item being transferred, a categorization, information about the parties to blockchain smart contract 334, information about the terms of blockchain contract 334, information about the transaction message, information about central service 308 and its role in the intended transaction, and/or any other data or metadata directly or indirectly relevant to the execution of blockchain contract 334, which may be utilized by buyer's service(s) 312, payment network 310, and/or seller's service(s) 314.

Information about the blockchain smart contract 334 may include, for example, at least one contractID for blockchain smart contract 334, and/or at least one tokenID for token 351, and/or a description of a blockchain contract 334.

Data about the item being transferred may include, for example, data and/or metadata about stock-keeping unit(s) (SKU) of the item as represented by NFT(s) 338.

A categorization may include, for example, a “merchant category code” (MCC), “transaction type indicator” (TTI), and/or Trace ID (i.e., DE 48, subelement 63, which links a refund to a prior purchase) that may provide additional information pertinent to buyer's servicer 312.

Information about the parties to blockchain contract 334 may include, for example, address(es) and/or association of seller's fiat account(s) 322 to sellers off-chain wallet 340 and/or association of buyer's fiat account(s) 302 to buyer's on-chain wallet(s) 332.

Information about the terms of blockchain contract 334, may include, for example, state data 361 and/or methods 362 that may govern execution.

Information about the transaction message may include, for example, information about authentication or authorization requests and responses, such as 3DS2.0, or any other data contained in the transaction message or about the transaction message.

Upon receipt of a transaction request, which may include additional pass-through data elements and/or metadata elements, the buyer's servicer 312 may respond to the payments network 310 using traditional payments rails, which are methods and systems that will be apparent to persons having skill in the relevant art. This includes without limitation a transaction message formatted based on one or more standards for the governance thereof, such as the International Organization for Standardization's ISO 8583 or 20022 standards.

Upon receipt of a transaction message, the payments network 310 may transform and/or convey the transaction message to one or more of the seller's servicer 314, using methods and systems that will be apparent to persons having skill in the relevant art.

At any time, any of the entities or intermediaries 302, 312 (a-d inclusive), 310 (316 inclusive), 314 (a-k inclusive), and/or 322 may convey the transaction message or metadata thereof (including without limitation any request and/or response) to central service 308 via message paths 303, 313, 311, 315, and/or 307, respectively. This may be executed via a direct integration, commercially available services such as Card Linked Offers, public or private API endpoints, webhook(s), and/or transaction switching, using methods and systems that will be apparent to persons having skill in the relevant art.

Central service 308 has the capability to access any transaction message of any type in any format that may convey the details and/or status of a pending or completed transaction involving buyer 301 and seller 323 or their representatives.

In some examples, at least one token 351 on blockchain 350 may be associated with the central service 308. It should be appreciated that token(s) 351 may be a single token, or may include more than one token.

Token 351 may be a non-fungible token, dynamic or non-dynamic, utilizing standards such as ERC-721, ERC721A, ERC-1155, ERC-6551, ERC-998, ERC-777, or other similar standard(s), which may be deployed on blockchain 350. Alternatively, token 351 may utilize token standards commonly utilized by blockchains other than Ethereum, such as BEP-721 or SPL, which may be deployed on blockchains such as BNB Chain or Solana. Alternatively, token 351 may be an ordinal, which may natively contain certain data or metadata absent a TokenURI or external call.

It should be appreciated that a pre-minted token collecting data elements/metadata elements from a number of transaction messages occurring over a period of time may be collecting data about transaction messages related to different contracts 334, between different buyers and sellers for different NFT assets. It should further be appreciated that this may have a cost savings benefit in that one mint cost can be spread across multiple transactions (lowering transaction fees to those buyers and sellers whose contracts are included), and it also may have a security benefit in that central service 308 need only allow data access to its system via its own token 351, rather than several individual contracts 334.

Token 351 may read, store and/or transmit any data element or metadata element or any part thereof from or pertaining to one or more transaction messages known to central service 308 (via one or more of message paths 303, 313, 311, 315, and 307), including without limitation via message path 330. Such data or metadata elements may include, without limitation, data or metadata elements pertaining to a transaction message conveyed by or via payments network 310, which may be formatted in any suitable format, as discussed herein. This confirmation may be stored, synthesized, or summarized into metadata; alternatively, it may be stored in its original format.

This data or metadata may convey, without limitation, any transaction message that expresses an authorization approval, settlement guarantee, or other protection from settlement risk (such as a 3DS2.0 authentication response or other message as described herein). This protection, which is understood by persons having skill in the relevant art, may be extended by payment network 310, and enforced upon buyer's servicer 312, for the benefit of seller's servicer 314, for the ultimate benefit of seller's fiat account(s) 322. This guarantee may result in an ‘approved’ or ‘transaction complete’ message on a physical terminal or a virtual payment gateway, thereby enabling the release of goods or services from seller 323 to buyer 301 prior to the actual settlement, using methods and systems on traditional payments rails that will be apparent to persons having skill in the relevant art.

These data or metadata elements may include, without limitation, any transaction message that expresses the result of a 3DS Authentication attempt, or the absence of such an attempt. This includes, for example, Authentication Response Codes that are blank or alphanumerical, signifying the existence or absence of a liability shift, using methods and systems that will be apparent to persons having skill in the relevant art.

A seller 323 and a buyer 301, or their representatives respectively, may enter into blockchain smart contract(s) 334. It should be appreciated that contracts 334 may be a single contract, or may include more than one contract.

Contract 334 may be deployed on blockchain 360. Buyer's on-chain wallet(s) 332 may be deployed on blockchain 390. Seller's on-chain wallet(s) 340 may be deployed on blockchain 370. It should be appreciated that blockchains(s) 350, 360, 370, and 390, may be the same blockchain network, different blockchain networks, or any combination thereof. For example, it may be preferable for token 351 to be minted on a blockchain with less costly transaction fees (e.g. lower gas costs).

Contract(s) 334 may be digitally “signed” by buyer's on-chain wallet(s) 332, or representative(s) thereof, and/or seller's on-chain wallet(s) 340, or representative(s) thereof. Representatives may include, for example, custodians or service providers that may have access to private key (such as hosted wallets), sharded elements of private keys (as in the case of a multi-party computation wallet), and/or who are required for contract execution (such as in the case of multi-signature wallets or smart contracts). Representatives may also include “smart contract wallet(s)” that utilize a “user operation” authentication method in lieu of a “signature” (for instance, in the case of ERC-4337 and EIP-7702).

Contract 334 may include or refer to state data 361, which may include a function to call, view, or ‘get’ data and/or metadata elements from token(s) 351. Alternatively, state data 361 may include a function to call, view, or ‘get’ data and/or metadata elements directly from central service 308 via message path 355. Such data or metadata elements, when achieving a pre-agreed state, results in the execution of the contract 334, subject to the terms of contract 334.

It should be appreciated that in the alternative embodiment where contract 334 includes a function to call, view, or ‘get’ data and/or metadata elements directly from central service 308 via message path 355, token 351 may or may not be part of system 300.

Contract 334 may refer to NFT 338, which may exist prior to contract execution. Alternatively, contract 334 upon execution may mint (create) NFT 338. NFT 338 may represent one or more goods, services, rights, titles, licenses, and/or any other value to be transferred permanently or non-permanently to buyer's on-chain wallet 332 (or representative thereof, including a smart contract wallet accessible to the buyer 301) upon execution of contract(s) 334. This may convey ownership to the buyer 301 (the resultant holder of NFT 338). Alternatively, NFT 338 may be held and/or minted by a third party, such as an escrow service or a contracting entity, until such time as contract(s) 334 execute. Contract 334 may refer to Buyer's on-chain wallet(s) 332, which may exist prior to contract execution or may be created by or for Central Service 309 or otherwise made available to Buyer 301 alongside or as part of Contract 334 (such as in the case of a “wallet factory” that creates new smart wallets on-demand). It should be appreciated that Buyer's on-chain wallet(s) 332 may be a smart contract wallet (or “programmatic wallet”), such as in the case of ERC-4337 or EIP-7702,

Pursuant to the satisfaction of any other conditions, such as those contained in method(s) 362, contract 334 may execute atomically once state data 361, token 351, and/or data or metadata elements known to central service 308 achieves a specified state. For example, subject to method(s) 362, contract 334 may execute automatically once state data 361 (derived from token 351, and/or data or metadata elements known to central service 308) achieves a state of ‘approved.’ This may satisfy consideration for the contract 334 and result in the mint and/or transfer of NFT 338.

Contract(s) 334 may include method(s) 362, which may include further instructions governing the contract (i.e., terms). The creators of contract(s) 334 may create, specify, embed, and/or reference method(s) 362, which may be called to perform a series of tasks under certain agreed conditions. This may include instructions that govern the execution of the contract. Method(s) 362 may be programmatically embedded into contract(s) 334. Alternatively, method(s) 334 may “call” external methods that exist outside of contract(s) 334. Method(s) 362 may only be applicable under certain conditions, which may include as the absence data, such as the absence of a 3DS2.0 “shift to issuer” authentication response.

Method(s) 362 may include instructions that survive contract execution, permanently or temporarily. Method(s) 362 may be called, but not modified, even after NFT(s) 338 is held in buyer's on-chain wallet(s) 332, including as a result of the appropriate execution of blockchain smart contract 334. This may include any pre-agreed conditions of dispute (such as refund, reversal, or chargeback) pertaining to the transaction message that served as consideration for the contract execution.

For example, method(s) 362 may include, without limitation, the ability to burn NFT(s) 338 (permanently delete or to transfer it to a private wallet inaccessible to anyone). This may occur remotely or non-remotely. This method 362 may be automatically executed subject to certain conditions specified in contract 334, such as a predetermined change in state data 361, token 351, and/or data and/or metadata elements known to central service 308. For instance, the predetermined change may include an indication of the lodging of a dispute, including dispute(s) with respect to the transaction message that served as consideration for contract execution.

For example, method(s) 362 may include, without limitation, terms to automatically repatriate NFT 338 to seller's on-chain wallet(s) 340, subject to the conditions of contract 334; alternatively, to deliver NFT 338 or to an agreed escrow custodian's wallet held on any blockchain, subject to the conditions of contract(s) 334.

For example, conditions to call method 362 may include, without limitation:
A dispute with respect to the transaction that served as consideration for the execution of contract(s) 334, such as:
A chargeback, reversal, refund, or similar dispute;
A certain type or reason code (e.g., fraud, technical error, etc.).
A specified status of the above (e.g., filed, under review, accepted)
A time-based validity period (e.g., 120 days from sale), which may align to the typical validity of a dispute window; post which, method(s) 362 may be programmatically disabled or unavailable.
A pre-agreed verification source, such as central service 308, having been the service upon which contract(s) 334 relied for execution, which may include multi-party verification and/or a consensus mechanism involving inputs from one or more of 302, 312, 310, 314, 322.

Further, method 362 may prevent the on-selling of NFT 338 for a pre-defined time period. This may correspond to a chargeback validity window. This may prevent the holder (buyer's on-chain wallet(s) 332) from disposing of the asset (NFT 338) for a specified period. Further, at the conclusion of the pre-defined time period, method 362 may automatically transfer the asset from a smart contract wallet to a buyer's EOA wallet.

In some examples, this time-based restriction may be waived upon mutual agreement of buyer's on-chain wallet(s) 332 and seller's on-chain wallet(s) 340. This may be achieved via reference to an additional (or second) smart contract (not shown). This may be executed by mutual consent after the execution of first contract(s) 334 and transfer of NFT 338 to buyer's on-chain wallet(s) 332, to release the on-selling restriction. This may, for example, occur when a buyer separately provides an escrow (via off-chain fiat or on-chain cryptocurrency) to the seller to guard against a subsequent reversal of fiat payment after the immutable asset transfer.

In the case that a method 362 is called, which may result in the permanent deletion, repatriation, and/or escrow of NFT(s) 338, central service 308 may observe and report status and/or outcome to any other entity in the block diagram. In the case that a method 362 is called, which may result in the removal of an on-selling restriction or any other change to the terms of contract(s) 334, central service 308 may observe and report status and/or outcome to any other entity in the block diagram.

The methods and systems discussed herein accordingly provide for the efficient conveyance of transaction messages to blockchain environments, which provide significant benefits in terms of usability, flexibility, and risk mitigation to buyers and sellers for the efficient execution of blockchain contracts using fiat currency.

By using traditional payment rails and transaction messages, which are more easily accessible than cryptocurrency, buyers and sellers can more easily rely upon payment network settlement guarantees to transfer ownership, release goods, and confirm the conveyance of goods, services, license, title, and rights in blockchain environments.

Moreover, the methods and systems herein accordingly provide for seller protections familiar to users of payment networks, such as disputes and chargebacks, by enabling automated recourse in the form of repatriation or escrow of NFT(s) 338 during or following a pre-designated dispute validity period.

Therefore, the methods and systems discussed herein can provide for significant improvement over the traditional processing of blockchain contracts, which typically rely upon cryptocurrency as the medium of exchange, by efficiently delivering payment confirmations and communicating settlement guarantees to sellers in blockchain environments via existing off-chain transaction message standards.

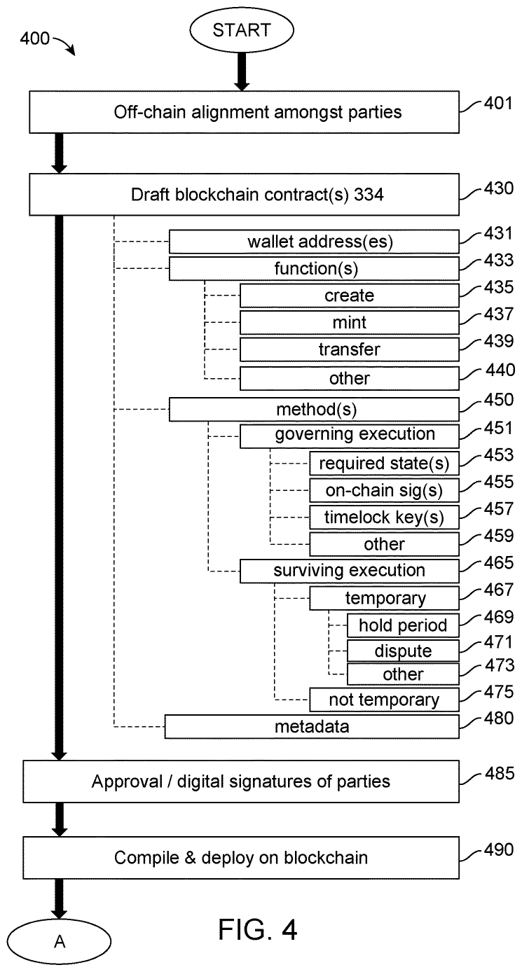

FIG. 4 illustrates a process flow or method 400 for creating, deploying, and executing contract(s) 334 that utilizes off-chain transaction messages via central service 308 as one input to automatically execute an exchange that results in the permanent or temporary conveyance of NFT(s) 338 to buyer's on-chain wallet(s) 332, subject to terms set out in or referenced by contract(s) 334, in accordance with embodiments and alternatives described herein.

In step 401, buyer 301 and seller 323 may agree to the terms of a proposed contract. This agreement may be facilitated by a service provider, such as central service 308, which may provide tool(s) such as a user interface to simplify negotiation and/or summarize terms. This may be provided directly from central service 308 to buyer 301 or seller 323, or via parties 302, 312, 310, 314, and/or 322 to buyer 301 or seller 323. This may be embedded in an online purchase or shopping cart experience. Alternatively, this may be provided by at least one of entities 302, 312, 310, 314, and/or 322 without the involvement of central service 308. In an embodiment where central service 308 is not provided by one of those entities, then the agreed terms would be conveyed by at least one of those entities to central service 308. In another alternative, central service 308 may be part of or controlled by at least one of entities 312, 310, 314 or the like.

In step 430, the agreed terms may be coded into at least one contract 334. This step may utilize a programming language (such as Solidity, Vyper, Rust, Cairo, or the like) and/or an integrated development environment (such as Remix, Hardhat, Truffle, or the like). It may be tested in a testing environment (such as Goerli, or the like). It should be appreciated that the contract 334 may be a single or multiple contracts 334, and it should further be appreciated that each of the at least one data elements and/or NFT(s) may be singular or plural (and references written as singular or plural should not be read to exclude the other unless specifically noted). Similarly, it should be appreciated that the methods, functions, and other contract components recited below and herein may be single or multiple, and references written as singular or plural should not be read to exclude the other unless specifically noted.

Contract 334 includes at least one data element, such as a wallet address 431, a function 433, a method 450, and a metadata element 480. Contract 334 may refer to at least one existing NFT 338 and/or result in the creation of at least one NFT 338.

The wallet address 431 may be one or more of buyer's on-chain wallet(s) 332, seller's on-chain wallet(s) 340, wallet(s) held by central service 308, wallets to be created “on demand” via a wallet factory (including, without limitation, smart contract wallets), wallet(s) governing contract execution (which may be of any nature including without limitation those that are multi-party computation (MPC), dedicated key management system (DKMS), multi-signature, and the like), and/or any other wallet address(es) relevant to contract(s) 334.

The function 433 is the programmatic logic that runs upon contract execution. Function 433 may include, for example, one or more create function(s) 435, one or more mint function(s) 437, one or more transfer function(s) 439, or one or more other functions (not shown).

Create function(s) 435 may include one or more of at least one address to which the at least one NFT 338 will be minted, (in some examples this may be buyer's on-chain wallet(s) 332) a tokenID(s) for the NFT 338 that will be minted, a tokenURI(s) (that is the address for metadata for the NFT 338), or any other suitable function.

Mint function(s) 437 may include one or more of at least one address to which the at least one NFT 338 will be minted (in some examples this may be buyer's on-chain wallet(s) 332, or the address of the owner for whom the new NFT 338 is minted), a tokenID(s) for the NFT 338 that will be minted, or any other suitable function. It may additionally include a tokenURI(s) (that is the address which may be utilized by NFT 338 to access data or metadata elements); alternatively, it may incorporate data or metadata directly into at least one NFT 338 (as in the case of an ordinal).

Transfer function(s) 439, which may include the ‘address from’ owner(s) of the NFT(s), which may be seller's on-chain wallet(s) 340; the ‘address to’ recipient of the NFT(s), which may be buyer's on-chain wallet(s) 332; and tokenID(s) for the token(s) that will be transferred, which may be NFT(s) 338.

Contract(s) 334 may include at least one method 450, which may be the same as method(s) 362.

The at least one method 450 may include one or more methods governing execution 451 and/or one or more methods surviving execution 465. A method governing execution 451 results in the automatic execution of contract 334 subject to other conditions, while a method governing survival may persist temporarily or non-temporarily after contract(s) 334 has been executed.

Method(s) governing execution 451 may include one or more of required state(s) 453, on-chain signature(s) 455, timelock keys(s) 457, and other term(s) 459.

Required state may be the same as state data 361. The at least one required state 453 may articulate the pre-agreed state of token(s) 351 and/or data or metadata known to central service 308 (such as “authorized,” “approved,” “authenticated,” “confirmed”, “cleared”, “settled”, or any other suitable state or status) that must exist in respect of a transaction message to automatically execute contract(s) 334 (subject to other conditions of the contract, if any).

On-chain signature 455 may require digital signatures or confirmation thereof from one or more parties to the transaction, such buyer's on-chain wallet 332 and/or seller's on-chain wallet 340, central service 308, and/or representatives respectively thereof (which may be one of the entities previously described herein. It may, for example, utilize a multi-signature smart contract, such as Gnosis Safe, to sign contract 334. Alternatively, it may utilize a multi-party computation contract, dedicated key management system contract, or any other suitable contract type to sign contract 334. This may include a smart contract wallet that utilizes a “user operation” authentication method in lieu of a “signature” (such as in the case of ERC-4337 and EIP-7702).

Timelock keys 457 may stipulate a time during which contract 334 may be executed (subject to other conditions of the contract, if any), post which, contract 334 may be unable to execute. This is a buyer and seller protection mechanism which may ensure that off-chain transaction messages occur within a pre-determined period.

Method(s) governing execution 451 may include other terms 459, which may be other terms or conditions that, once satisfied, may result in the automatic execution of contract(s) 334, (subject to other conditions, if any).

A method surviving execution 465 may become attached to or associated with NFT(s) 338, even once held in buyer's on-chain wallet 332, for instance in the case of a dispute. A method surviving execution 465 may govern the NFT(s) 338 and/or may govern the buyer's on-chain wallet 332 in respect of NFT(s) 338. A method surviving execution 465 may have an override mechanism, which enables parties upon mutual digital signatures to revise method 465 following the execution of contract 334.

Method(s) surviving execution 465 may include temporary method(s) 467, which persist only for a pre-determined time period. This time period may be absolute, for example in the form of a date and/or time certain. Alternatively, this time period may be relative, for example relative to the execution of contract(s) 334.

Temporary method(s) 467 may include one or more of a holding period 469, a dispute call 471, and other terms 473.

A holding period provides for a time period during which NFT 338 may be programmatically unable to be transferred. For example, this may prevent buyer's on-chain wallet 332 from transferring or disposing of NFT 338 for a time period, absolute or relative, as agreed by the parties. This holding period may prevent, for example, a buyer from on-selling NFT 338 and then subsequently lodging a payment dispute, such as a chargeback request with their method of payment.

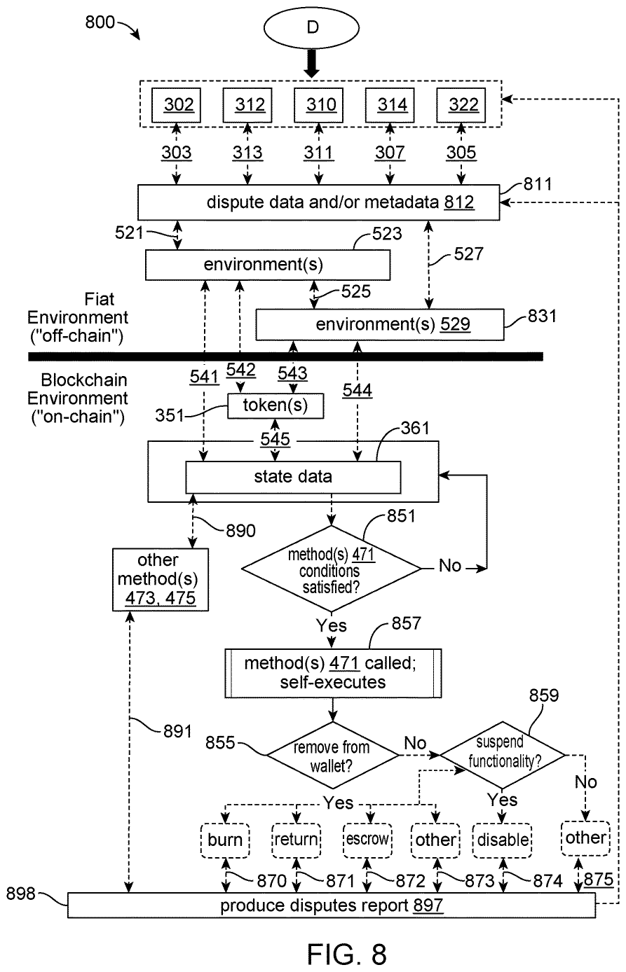

A dispute call 471 may provide a pre-established processes for the handling of a dispute following the execution of contract(s) 334, based on trigger condition(s) pursuant to the state data of the associated fiat transaction(s). For example, it may provide for the automatic deletion (“burn”), repatriation, or escrow of NFT 338 in the event of a transaction dispute filed by the buyer post-execution. A dispute call is a form of seller protection, and is discussed in greater detail with reference to FIG. 8.

Other terms 473 may be other conditions that, once satisfied, may result in the automatic execution of contract(s) 334 (subject to other conditions, if any). For example, other terms 473 may include specialized terms such as warranties, return policies, insurance requirements, tax obligations, a third party lien or claim on the item, and/or dependencies to execute other contracts within a specified period following the execution of contract(s) 334.

A method surviving execution 465 may additionally or alternatively include one or more non-temporary methods 475, which may persist indefinitely. This may include, for example, methods that permanently record a ledger of ownership, chain of title, or provenance of NFT 338, a third-party lien or claim on the item, and/or those which provide durable benefit(s) to the holder of NFT 338 such as permanent insurance.

Contract(s) 334 may include metadata elements 480, which may capture metadata pursuant to the contract. For example, this may include information that assists central service 308 to associate a given transaction message with contract(s) 334.

Metadata 480 may contain information that assists central service 308 to associate buyer's on-chain wallet(s) 332 with buyer's fiat account(s) 302, which may include account number (inclusive of digital PAN, tokenized PAN, etc.), cardholder name, financial institution, demographic, geographic, “know your customer” data, “know your business” data, and/or decisions, “anti-money laundering” data and/or decisions, “know your business” data and/or decisions, and and/or other information which may support in the identification of the buyer with respect laws and/or regulations of any jurisdiction.

Metadata 480 may contain information that assists central service 308 to associate seller's on-chain wallet(s) 340 with seller's fiat account(s) 322, such as at least one of merchant ID (MID), card network assigned ID (e.g., MAID), merchant category code (MCC), merchant name, address, country, gateway, acquirer, ISO, card acceptor business (CB) data, receiving institution, accepting institution, “know your customer” or data and/or decisions, “anti-money laundering” data and/or decisions, “know your business” data and/or decisions, and other information which may support in the identification of the buyer with respect laws and/or regulations of any relevant jurisdiction.

Metadata 480 may contain information that assists central service 308 to understand the nature of contract 334 and/or NFT 338, such as stock-keeping unit (SKU) data, item description, item category, transaction type indicator (TTI), transaction identifier (TraceID, TranID, ARN), country, or other information that will aid parties to understand, price, and/or reduce fraud associated with a transaction.

Metadata 480 may contain any information pertinent to contract(s) 334 and/or NFT 338.

In approval step 485, upon drafting of contract(s) 334, parties such as buyer and seller or representatives respectively thereof may approve the terms of contract(s) 334, prior to deployment in step 490. Approval step 485 is an optional step. Approval step 485 may be conducted via an off-chain approval process, such as via a user interface that presents the contract to parties in summary form, a lay-readable format, and/or original programming language. To complete approval step 485, central service 308 may convert or summarize the draft programming language into human-readable format for acceptance by both parties; alternatively or additionally, central service 308 may present original programming language to both parties for approval, prior to deployment. Approval may take the form of off-chain digital signatures, physical signatures, click-wrap consent, or other suitable form of signature and consent to be bound. It should be appreciated that this may be provided directly from central service 308 to buyer 301 or seller 323, or via entities 302, 312, 310, 314, and/or 322 to buyer 301 and/or seller 323. This may be embedded in an online purchase or shopping cart experience. Alternatively, this may be provided by at least one of entities 302, 312, 310, 314, and/or 322 without the involvement of central service 308. In an embodiment where central service 308 is not provided by one of those entities, then the agreed terms would be conveyed by at least one of those entities to central service 308. In another alternative, central service 308 may be part of or controlled by at least one of entities 312, 310, 314 or the like.

In step 490, contract(s) 334 may be compiled and deployed on any blockchain, including public, private, consortium, hybrid, sidechain, rollup, layer 2, layer 3, layer n, etc. This may involve one or more sub-steps to compile the contract(s), generating bytecode, a deployment script or plugin, and access to a blockchain node. The methods and systems to compile and deploy a smart contract onto a blockchain will be apparent to persons having skill in the relevant art.

Upon deployment of contract(s) 334, a contract's public address will be generated (contract ID), which may consist of a combination of a public address of the creator's account and a nonce, using methods and systems to that will be apparent to persons having skill in the relevant art.

Contract(s) 334 will thus be active on the blockchain, awaiting satisfactions of the pre-conditions to cause execution and the method can proceed to steps A.

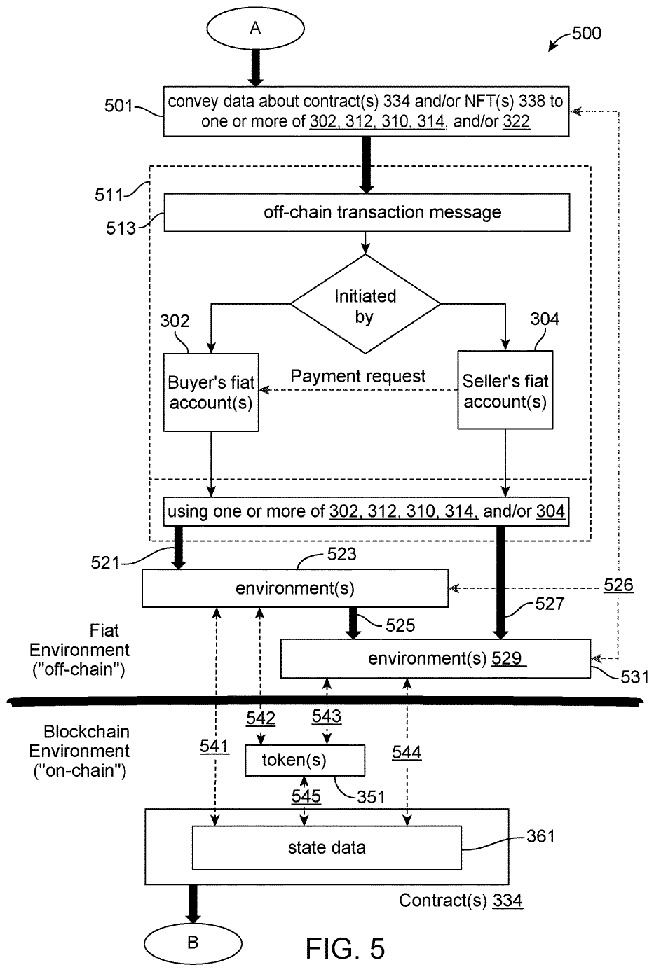

FIG. 5 illustrates a process flow or method 500 for observing, summarizing, and conveying off-chain transaction messages. Such messages may be processed by central service 308 for use by on-chain contract 334 as an input for automatic execution.

The process begins at step A of FIG. 4. In step 501, data about contract 334 and/or NFT 338 from step 490 may be provided as input into an off-chain payment event. The nature of contract 334 and/or NFT 338 may be made known to one or more of 302, 312, 310, 314, and/or 322. This may include information that assists any party to understand the nature of contract 334 and/or NFT 338, such as stock-keeping unit (SKU) data, item description, item category, transaction type indicator (TTI), transaction identifier (TraceID, TranID, ARN), country, and/or any other information that may aid parties to understand, price, and/or reduce fraud associated with a transaction

This may result in the generation of a transaction message 513. Payment network 310, utilizing transaction messages, may process payment relative to contract 334. Transaction message 513 may be generated by central service 308, including the data and/or metadata about contract 334 and/or NFT 338. Additionally or alternatively, transaction message 513 may be generated by one or more of 302, 310, 312, 314, and 322 utilizing data and/or metadata provided by central service 308.

For example, in the instance of a credit card transaction utilizing ISO 8583:2023, transaction message 513 may be created as an authorization request message type 1100 with appropriate fields such as 18 (MCC), 26 (card acceptor business type), 04 (amount transaction), 62 (private), and any other fields. The transaction message 513 may be created by and/or provided via 314 to payment network 310 which may relay the message to an issuer 312 for authorization.

In another example, for a payment initiation request utilizing ISO 20022:2013, transaction message 513 may be created by and/or provided via one or more of 314, 310, 312, 322, and 302 to one or more of 314, 310, 312, 322, and 302 utilizing any descriptive fields within pain.001.001.11 or pain.002.001.13 that may contain details appropriate to contract 334 and/or NFT 338.

It should be appreciated by one of skill in the art that data about contract 334 and/or NFT 338 may be provided to and inform any transaction message type from any known payments protocol or data standard as described with reference to transaction message herein.

As depicted by box 511, the off-chain payment event may be embedded within central service 308. That is, buyer and seller may interact directly with central service 308, such as via a shared user interface, platform, and/or application, which may include capabilities provided by one more of 312, 310, and/or 314. For example, this may include the ability for buyer 301 and seller 323 to access payment providers (inclusive of parties 312, 310, and/or 314) via a dashboard, client, application, API, or other such service that is made available from central service 308, directly or indirectly, with which buyer's fiat account(s) 302 and/or seller's fiat account(s) 322 or their representative(s) respectively, may interact to complete payment. This payment may be completed via means such as cards (credit, debit, prepaid), account-to-account, peer-to-peer, money transmitter, open banking, RTP, payment facilitation, digital wallet, and/or staged digital wallet, or any other transaction message.

Alternatively, off-chain payment event(s) may occur on traditional payments rails, independently to central service 308 and absent 511. That is, buyer's fiat account(s) 302 and seller's fiat account(s) 322 may interact directly or indirectly with one another, via one or more of 302, 312, 310, 314, and/or 322, absent direct interaction with central service 308. In this instance, central service 308 may have integrations with one or more of 302, 312, 310, 314, and/or 322 that enable central service 308 to view transaction message data or metadata. For example, this may occur via data feeds provided and/or permissioned by one or more of 302, 312, 310, 314, and/or 322.

Off-chain payments may be initiated by buyer using buyer's fiat account(s) 302, for example by inputting a card number into an ecommerce gateway, tapping a card on a physical terminal, and/or pushing a payment using a digital wallet, open banking, and/or a real-time payments network. This may be in response to a payment request from the seller. Alternatively, off-chain payments may be initiated by a seller via a “pull” method, such as a direct debit, recurring payment, card on file, or other suitable process as may be understood by one of skill in the art. Payment(s) may be executed via any payment network 310 using methods and systems that will be apparent to persons having skill in the relevant art.

One or more transaction messages may be observable by central service 308, which may occur via path 521 and/or 527. Such observability may be enabled, for example, via permission from buyer or seller, or representative(s) thereof respectively, which may include a financial institution or service provider. Alternatively or additionally, it may be enabled via buyer or seller enrollment in a card-linked-offer program such as “Visa Offers Platform” or “Mastercard Personalized Card Linked Offers. Alternatively or additionally, it may be enabled via integration(s) with one or more entities 302, 312, 310, 314, and/or 322.

For the avoidance of doubt, transaction message(s) may include the absence of an expected transaction message. This absence may be communicated via paths 521 and/or 527. For example, in the case of a transaction for a recurring subscription, the subscription services may be disabled absent a valid transaction message within a specified period.

A transaction message, including those which may contain embedded data or metadata about contract(s) 334, such as metadata 480, may be associated and/or validated with contract(s) 334 via path 526. This association and/or validation may be performed by central service 308 or by the other entities involved in the transaction.

Via path 521, a transaction message and/or data elements thereof may be stored in at least one centralized and/or decentralized data storage environment 523. Environment 523 may be accessible to central service 308, token 351, and/or state data 361. Environment 523 may be operated by, accessible to, and/or permissioned to central service 308.

Via path 525 and/or 527, a transaction message may be extracted, processed, transformed, summarized, loaded, sharded, encrypted, and/or similarly manipulated from data elements to metadata elements. Metadata elements of a manipulated transaction message, may be stored in centralized or decentralized metadata storage environment 529. In an embodiment where both data elements and metadata elements are held environment 529 may be the same as environment 523, or they may be separate, as shown. In another alternative embodiment, metadata storage environment 529 may receive a transaction message and process it to metadata. Metadata storage environment 529 may be accessible to central service 308, token 351, and/or state data 361. Metadata storage environment 529 may be operated by and/or permissioned to central service 308.

In metadata storage environment(s) 529, transaction message(s) may be transformed and/or summarized to metadata. This may include the removal of personal identifiable information. Alternatively, this information may have been removed prior to transmission via path 527. Remaining transaction message data elements and/or metadata elements may include those which are relevant to contract(s) 334 such as at least one of transaction identifier(s), buyer identifier(s), seller identifier(s), intermediary identifier(s), descriptive data, transaction status, request codes, response codes, authentication codes, authorization codes, liability shift(s) such as 3DS2.0, payment confirmations, clearing status, settlement status, and/or dispute status (if any).

It should be appreciated that although environments 523 and 525 are shown on the off-chain side of FIG. 5, they could alternatively be provided on-chain, or at least one could be provided on-chain and at least one other could be provided off-chain.

None, either, or all of environment 525 and environment 529 may maintain ongoing integrations with other entities via message paths 521, 525, and/or 527. These ongoing integrations may, for example, continue to monitor the status of transaction messages associated with contract(s) 334, which may include buyer's fiat account(s) 302 and/or seller's fiat account(s) 322. For example, these environments may continuously monitor for disputes, reversals, refunds, and/or chargeback claims related to the transaction message that satisfied state data 361 and/or resulted in the execution of contract(s) 334. Data and/or metadata about such claims may be made available to token 351 and/or state data 361, even after the execution of contract(s) 334, which may be utilized to initiate dispute method 471.

Tokens 351 may access data elements and/or metadata elements about one or more transaction messages via paths 542 and/or 543. For example, token 351 may be a dynamic NFT, with a tokenURI that programmatically updates based on the contents of environment (532 and/or environment 529.

Token 351 and/or state data 361 may thus be updated with variable data pertinent to execution of contract(s) 334 and the method can proceed to step B.

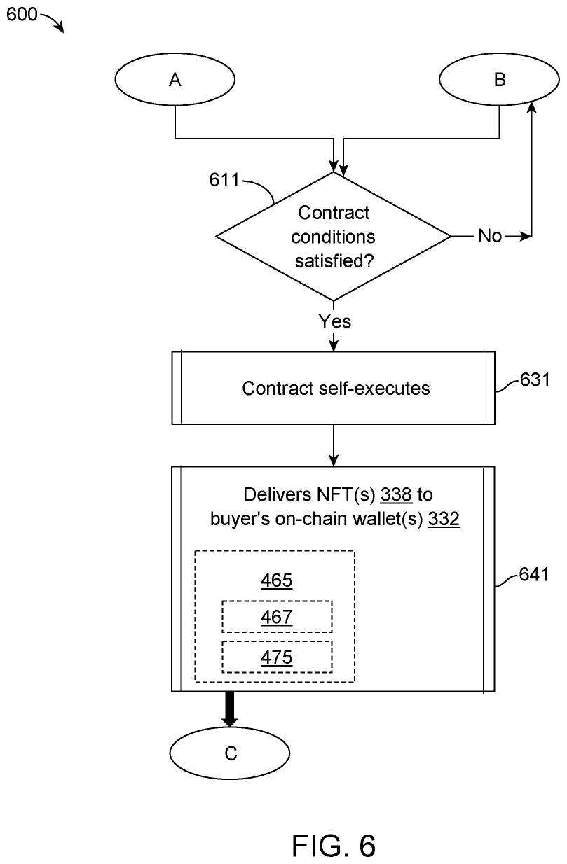

FIG. 6 illustrates a process flow or method 600 for executing contract(s) 334 upon the conformance of step B variables to pre-defined conditions deployed in step A.

In step 611, the contract(s) 334 deployed in step A may continuously monitor state data 361, token(s) 351, and/or off-chain data or metadata known to central service 308 in step B, such as that of data storage environment 523 and/or metadata storage environment 529. This data may be reflected in state data 361. It should be appreciated that such continuous monitoring may be performed at regular intervals with some time delay, or constantly. It may be additionally or alternatively be performed on a push and/or pull basis.

To execute contract(s) 334 (subject to other conditions, if any), the token 351 and/or state data 361 from step B may need to have a certain value (such as “authorized,” “approved,” “authenticated,” “confirmed”, “cleared”, “settled”, or any other suitable state or status) in respect to the transaction message(s) associated with contract(s) 334.

Absent the appropriate value from step B, contract(s) 334 will remain unexecuted as the contract conditions will not be satisfied. Contract(s) 334 will continue to check step B for conformance, according to the method(s) governing execution 451, which may include timelock key 457.

In step 631, once step B conforms to the pre-defined value specified by A, (subject to other conditions, if any (such as those which may be specified in method(s) 451), the contract conditions are satisfied, and contract(s) 334 automatically self-executes according to the predetermined process in contract 334.

In step 641, upon execution of contract(s) 334 and subject to its terms, NFT(s) 338 as well as any method surviving execution 465 is delivered to buyer's on-chain wallet(s) 332 according to the predetermined process in contract(s) 334. This process may include one or more functions 433 such as to create 435, mint 437, and/or transfer 439.

Method surviving execution 465 may continue to apply to NFT 338, even once held by wallet(s) 332. This may include, for example, dispute method 471, which may govern the deletion, repossession, and/or escrow of NFT 338 in the event of a dispute of the fiat transaction (as further described with reference to FIG. 8). This may include, for example, hold period method 469, which may programmatically prohibit buyer's on-chain wallet 332 from disposing of, transferring, lending, and/or deleting NFT 338 for a predefined period of time. For instance, this predetermined period of time may correspond to period during which a dispute may be filed. Method surviving execution 465 may additionally or alternatively include other methods 473. This may include non-temporary method 475.

Thus, buyer's on-chain wallet(s) 332 may hold NFT 338 which may include method surviving execution 465 and the process continues with C.

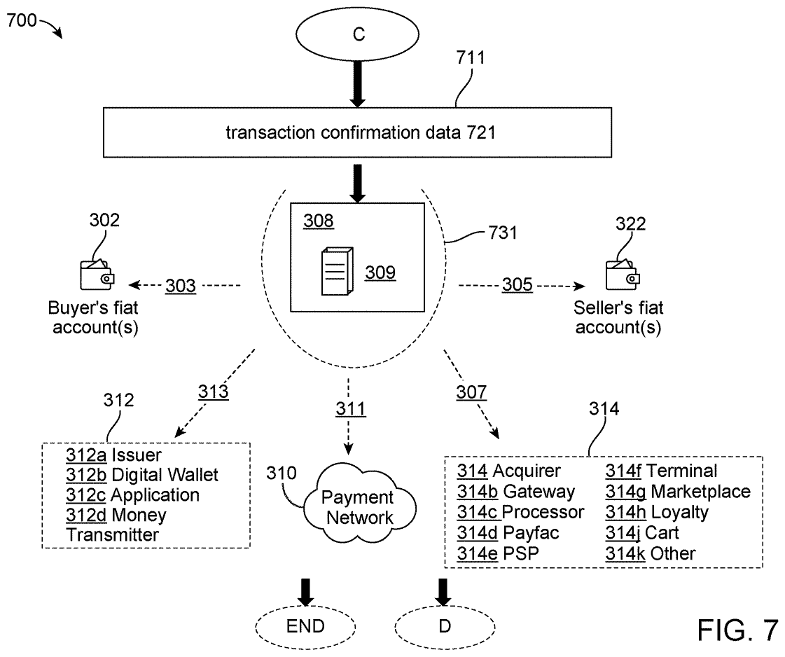

FIG. 7 illustrates a process flow or method 700 for reporting and validating the proper delivery of NFT 338 to buyer's on-chain wallet(s) 332, and evidencing the same to off-chain parties, who may have participated in the transaction.

In step 711, upon completion of step C from FIG. 6, central service 308 may receive or create transaction confirmation data elements 721. This may include, for example, event log fields associated with the transaction, such as address, topics, data, blockNumber, timestamp, gasPrice, gasUsed, logIndex, transactionHash, and/or transactionIndex, using methods and systems that will be apparent to persons having skill in the relevant art.

Central service 308 may perform additional confirmatory searches or processing to validate the successful delivery of NFT 338. This may include, for example, a function (such as getOwnersForToken) that looks up NFT 338 by contractAddress and/or TokenID to confirm that the wallet address matches the wallet address of buyer's on-chain wallet(s) 332. Such confirmatory searches and functions may be completed using methods and systems that will be apparent to persons having skill in the relevant art.

In step 731, central service 308 with processor 309 may receive, process, store, and/or report on-chain transaction confirmation and/or ownership data to one or more of parties 302, 312, 310, 314, and/or 322 via paths 303, 313, 311, 307, and/or 305, respectively.

In some instances, this information may be made available only to those parties who participated in and/or supplied the transaction messages that led to the successful execution of contract 334 from B in FIG. 5. In some instances, this information may be automatically compiled and formatted by central service 308 into a structured data template, which may include data fields such as customer information, delivery address, device ID, IP address, or other data elements acceptable to card network dispute services, such as Visa Compelling Evidence (CE) 3.0. It should be appreciated by one of skill in the art that this may be referred to in industry as a chargeback rebuttal letter, which often is, but need not be, in the form of an actual letter.

Applicants have surprisingly found that it is possible to efficiently report transaction confirmation data to entities 302, 312, 310, 314, and/or 322, and that this is an efficient method to confirm the on-chain disposition of assets. This transaction confirmation data 721 is highly useful to fiat payment networks and its members, as it may curtail dispute claims in an automated fashion without requiring an investigative process.

Furthermore, applicants have surprisingly found that this process successfully enables the reassociation of an on-chain transfer of assets (such as event-logs) with an off-chain fiat payment event (such as a transaction message) via central service 308 that has unprecedented visibility to confirm both on-chain offer, off-chain consideration, and on and off chain settlement. Applications have thus surprisingly found a new way to incorporate the familiarity and pre-existing processes of traditional payments rails with the antithetical blockchain payments space. Furthermore, applicants have surprisingly found ways to de-risk the transfer via buyer and seller protection mechanisms such as dispute method 471, timelock key 457, and others as described herein.

In the case that dispute method 471 is called, which may result in the permanent deletion, repatriation, and/or escrow of NFT 338 (and as shown in greater detail in FIG. 8) central service 308 may utilize 711, 721, and/or 731 to observe and report status and/or outcome to any other parties such as 302, 312, 310, 314, and/or 322.

In the case that surviving method(s) 464 are modified post-execution by mutual consent, should such capability exist, or change to the terms of contract(s) 334, central service 308 may utilize steps 711, and/or 731 to observe and report status and/or outcome to any other parties such as 302, 312, 310, 314, and/or 322 via paths 303, 313, 311, 307, and/or 305, respectively.

It should be appreciated that for contracts 334 with no methods surviving execution 465, the process ends after the transaction confirmation data 721 is reported. However, for contracts 334 where methods surviving execution 465 are employed, the process may continue until the expiry of those conditions (for temporary methods 467), it may remain pending indefinitely (for non-temporary methods 475), or it may continue to monitor for disputes. Should a dispute be filed, the process could be reopened or continued at D according to the example process shown in FIG. 8.

FIG. 8 illustrates a process flow or method 800 for monitoring transaction messages and addressing instances of disputes that may be related to the at least one transaction that contributed to and/or resulted in the execution of contracts 334.

Disputes may arise for a variety of reasons. Disputes can include or lead to chargebacks, which may involve a reversal of the transaction. Common types of disputes and/or chargebacks may include fraudulent transactions, billing errors, goods or services not received, defective merchandise, cancelled recurring transactions, double-charging, credit not processed, identity theft, and/or friendly fraud.

An example of a fraudulent transaction may be when a cardholder or banking entity identifies unauthorized transactions, sometimes due to stolen card information. An example of billing errors may be when a cardholder believes there was a mistake in billing, for instance for an incorrect amount. An example of goods or services not received may be when the cardholder claims a merchant failed to deliver the promised goods or services. An example of defective merchandise may be when a cardholder believes the goods significantly differ from description or are not fit for their intended purpose (broken, poor quality, incorrect, or the like. An example of cancelled recurring transactions may be when a cardholder cancels a subscription or recurring payment but continues to be charged. An example of double charging may be when the same transaction appears more than once. An example of credit not processed may be when a cardholder returns an item but does not receive the appropriate credit. An example of non-receipt of cash or merchandise from an ATM may be when a cardholder claims an ATM failed to deliver the promised cash or merchandise. An example of identity theft may be when a cardholder disputes a transaction as unauthorized. An example of friendly fraud (sometimes referred to as “chargeback fraud”) may be when a cardholder actually receives the goods but later disputes the charge, intentionally or unintentionally.

Different types of payment networks 310 may have different types of disputes, which may be communicated using different standards/and or formats. It should be appreciated that this method 800 may be capable of addressing or configured to address all types of disputes, of any nature, of any standard and/or format, that may arise following the execution of contract 334.

For example, dispute-related transaction messages in an ISO 8583 format may employ a message type indicator such as “reversal” (such as x4x0 or x4x1) and/or chargeback (such as x4x2 or x4x3). For example, dispute-related transaction messages in an ISO 20022 format may employ messageID such as those relevant to chargeback initiation (cain.027.001.xx) and/or chargeback response (cain.028.001.xx), customer payment reversal (pain.007.001.xx), customer credit transfer initiation (pain.001.001.xx), and/or payment return (pacs.004.001.xx).

Dispute-related transaction messages are a type of transaction message. Step 811 reflects the capture of dispute-related transaction message data elements and/or metadata elements 812 by central service 308. Similar to FIG. 5, dispute-related transaction messages and/or metadata thereof may become known or be communicated to central service 308 from one or more of entities 302, 312, 310, 314, and/or 322, via message path(s) 303, 313, 311, 307, and/or 305, respectively. It should be appreciated by one of skill in the art that any of these pathways may utilize intermediary service providers, including but not limited to chargeback alert networks (e.g., Verifi, Ethoca) or card-linked offer services, to provide such transaction status data.

Again similarly to FIG. 5, dispute-related transaction messages and/or metadata thereof may flow into environment 523 and/or environment 529 via message paths 521 and/or 527, respectively. Dispute-related transaction messages and/or metadata thereof may flow between environment 523 and environment 529 via path 525. Dispute-related transaction messages and/or metadata thereof, may flow between state data 361 and environment 523 via message path 541; between token 351 and environment 523 via message path 542; between token 351 and environment 529 via path 543; and/or between state data 361 and environment 529 via path 544.

The dispute call method 471 associated with contract 334 and/or NFT 338, which may have survived the execution of contract 334, may be activated upon the satisfaction of certain pre-agreed conditions. Thus, at step 851, the system checks to see whether the one or more conditions for method 471 are satisfied. For example, method 471 may be activated (“called” or programmatically executed) when at least one of entities 312, 310, or 314 approves a chargeback transaction message associated with the transaction underlying the transaction message in step 511 (which in turn caused required state 453 to change to a state that satisfied contract conditions in step 611 and caused contract 334 to self-execute in step 631).

If the condition(s) to call dispute call method 471 are not satisfied, no action may occur. Step 851 may continue to check for the satisfaction of conditions, subject to other terms, such as a timelock key 457 after which method 471 is unable to be called. This check may be continuous. It should be appreciated that such continuous monitoring may be performed at regular intervals with some time delay, or constantly. It may be additionally or alternatively be performed on a push and/or pull basis.

If the condition(s) to call dispute call method 471 are satisfied, the process moves to step 857. At step 857, methods 471 is called causing a program to execute. This may be a program that is unchangeable after the execution of contract(s) 334. Alternatively, or additionally, this may be a program that is modifiable after the execution of contract(s) 334, for example upon further on-chain signatures of interested parties. One or more programs associated with method 471 may be embedded in contract 334 and/or NFT 338 and/or buyer's wallet 332; alternatively, they may “call” to an external program.

The steps following 857 are optional and subject to the construction and agreed terms reflected in the method surviving execution.

For example, at step 855, the program may determine whether to perform a function to remove NFT 338 from the buyer's on-chain wallet 332. This may include, for example, a function 870 to “burn” (or permanently delete) the asset, return 871 the asset to the seller, escrow 872 the asset in a pre-agreed wallet, and/or any other suitable function 873 that may result in the removal of NFT 338 from the buyer's on-chain wallet 332.

For example, at step 859, the program may determine whether to perform a function to suspend the functionality or utility of NFT 338. For example, if NFT 338 is a dynamic NFT, method 471 when called may perform a function to disable 874 NFT 338 and/or any other suitable function 875 that may result in the suspension of utility associated of NFT 338. For example, it may remove NFT 338's connection with certain metadata, and/or modify the metadata to present differently. This may be relevant, for example, in use cases such as concert ticketing (disabling permission to enter a concert venue), software subscriptions (disabling license to the software), or other similar use cases.

It should be appreciated that, though described above as alternatives, the program underlying method 471 may perform functions to both remove NFT 338 and suspend functionality. Alternatively, the program may neither remove NFT(s) nor suspend functionality. It may, for example, alert one or more parties or entities. The program may execute any other suitable function that is supported by contract 334 and/or NFT 338 following the execution of contract 334.

Any of these outcomes of method 471 may result in the automatic production of a disputes report 897 in step 898.

Alternatively or additionally to step 851, at step 890 the other method 473 and/or non-temporary method 475 associated with contract 334 and/or NFT 338, which may have survived the execution of contract 334, may be activated upon the satisfaction of certain pre-agreed conditions. For example, method(s) 473 may be activated (“called” or programmatically executed) when payment network 310 and/or acquirer 314a and/or any other suitable entity receives a chargeback request transaction message associated with the transaction underlying the transaction message in step 511 (which in turn caused required state 453 to change to a state that satisfied contract conditions in step 611 and caused contract 334 to self-execute in step 631).

Other method 473 and/or 475 may execute any suitable program according to their logic. This may include, for example, automatically producing disputes report 897 at step 898. This may include, for example, a data package report that verifies the execution of contract(s) 334, consistent with FIG. 7 in a specified data format.

Disputes report 897 may be “on-chain” or “off-chain.” At step 898, a disputes report 897 may be provided to and/or via any one or more of environment 529, environment 523, 301, 302, 312, 310, 314, 322 and/or 323. For example, a disputes report may be provided in a format commonly utilized by payment network(s) 310 and/or its members such as acquirer 314a to contest chargebacks, which may be conducted via a dispute management system. For example, this may include a chargeback rebuttal letter, inclusive of relevant transaction data (which may include evidence from one or more figures contained herein), that may be utilized in a Mastercom® Dispute Resolution process or Visa Compelling Evidence 3.0 (or with other payment network) to dispute a claim. Additionally or alternatively, the disputes report 897 may be communicated to step 811 to update the dispute data elements and/or metadata elements 812.

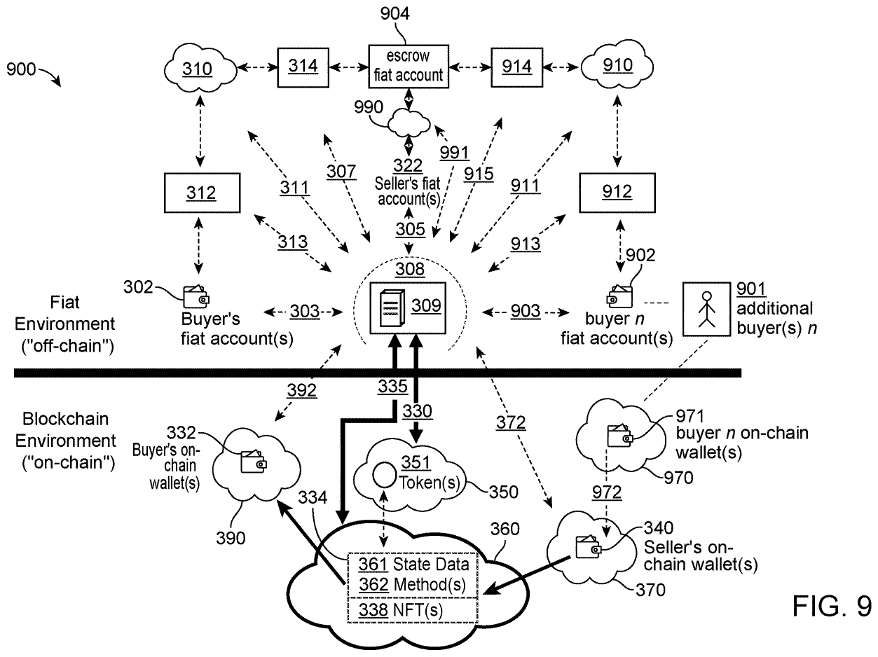

FIG. 9 illustrates a system 900 for receiving, processing, and efficiently conveying to blockchain contracts one or many transaction messages that may involve multiple payers, which may include embedding at least one method 362 that may inure certain rights, claims, interests, and/or benefits of NFT 338 to one or many buyers.

Like the system 300, a transaction occurs between the buyer 301 (represented by buyer's fiat account 302 and buyer's on-chain wallet(s) 332) and the seller 323 (represented by seller's fiat account 322 and seller's on-chain wallet 340).

However in the system 900, fiat account 902 may transact alongside buyer's fiat account 302. It should be appreciated that fiat account 902 may be one account, or many be many accounts. It should be appreciated that fiat account(s) 902 may be held by n different individuals or companies (additional buyers 901), where n may be any suitable whole, positive value. For example, fiat account 902 may belong to a lender, an investor, a depositor, a joint owner, and/or any other entity that may pay any amount for and/or assume any interest in NFT 338. Additional buyers 901 may additionally or alternatively be represented by additional buyer's on-chain wallet 971.

For example, fiat account 902 may belong to a bank, operating as a secured lender with respect to the purchase of real property. In this example, buyer's fiat account 302 may deposit 20% of a purchase value into escrow fiat account 904, whereas additional buyer's fiat account 902 may deposit 80% of the purchase value into escrow fiat account 904, which may be deposited under a loan arrangement with buyer 301.

In another or further embodiment, fiat account 902 may belong to an unsecured lender who lends capital that enables the buyer to purchase a good or service. Fiat account 902 may contribute any suitable amount, including without limitation the entire purchase price/value and/or more.

Fiat account 902 may utilize buyer's services 912, which may be the same as or similar to buyer's services 312 in FIG. 3. Fiat account 902 may utilize payment network 910, which may be the same as or similar to payment network 910 in FIG. 3.

Central service 308 may observe transactions via paths 903, 913, 911, and 907, which may be the same as or similar to paths 303, 313, 311, and 307 respectively, in FIG. 3.

The system may include escrow fiat account 904. This may be held by central service 308; alternatively, it may be held by any entity, including without limitation buyer 301/302, buyers 901/902, and/or seller 323/322 or any of 312, 310, 314, 912, 910, 914. Escrow fiat account 904 may consolidate payments from all buyers. Escrow fiat account 904 may utilize payment network 990, which may be the same as payment network 310 and/or 910, to remit payment to seller's fiat account(s) 322.

Alternatively, or additionally, additional buyer n 901 may contribute to the buyer's purchase of NFT 338 via any on-chain transfer of value to seller 323 (for example, of cryptocurrency, stablecoins, barter, and/or any other exchange of value). Buyer(s) n on-chain wallet(s) 971 may be created on blockchain 970, which may be the same as blockchains 350, 360, 370, 390. Value held in buyer's n on-chain wallet(s) 971 may be utilized to partially or fully subsidize the purchase of NFT 338, for the benefit of the buyer and for delivery of NFT 338 into buyer's on-chain wallet 332. Path 972, which transfers value from 971 to 340, may be atomically executed within Contract(s) 334, such that value is transferred via 972 simultaneous to the delivery of NFT(s) 338 to buyer's on-chain wallet(s) 332, upon execution of contract(s) 334. In an embodiment where additional buyer 901 is contributing on-chain consideration to the purchase, contract 334 may include method governing execution 451 which may require as a precondition confirmation of buyer 301's contribution of its portion to escrow fiat account 904, which may be evidenced by a transaction message observed and/or received by central service 308 in a similar manner to the other embodiments described herein.

Applicants have surprisingly found that this system delivers significant flexibility to lenders, secured and unsecured, that heretofore did not exist. In embodiments where lenders are using off-chain funds, lenders can require buyers to provide the first deposit to escrow fiat account 904, and then have the confidence to know that their second deposit can cause automatic execution of contract(s) 334 and transfer NFT 338 to the buyer's on-chain wallet 332. In embodiments where lenders are using on-chain funds, lenders can rely on contract 334 to simultaneously withdraw lending capital via path 972 and deliver NFT(s) 338 to buyer's on-chain wallet(s) 332. In a further embodiment, the lender can rely on this only occurring once buyer 301 has transferred its portion to escrow fiat account 904 (which may be evidenced by a transaction message observed and/or received by central service 308 in a similar manner to the other embodiments described herein, and which evidence may cause contract 334 to execute).

Moreover, one or more temporary method 473 and/or one or more non-temporary method 475 may be customized to suit the financial agreements amongst multiple buyers. For example, contract 334 may include and/or call methods that automatically execute foreclosure steps upon default, transferring ownership of NFT 338 to the lienholder or an escrow service, or any other such terms such as recourse as may be typically agreed amongst buyers and financiers.

Applicants have surprisingly found that this system, which enables multiple buyers to purchase NFTs and can incorporate durable methods governing buyers' ongoing interests relative to NFTs 338, delivers novel advantages unavailable with current systems or payment methods.

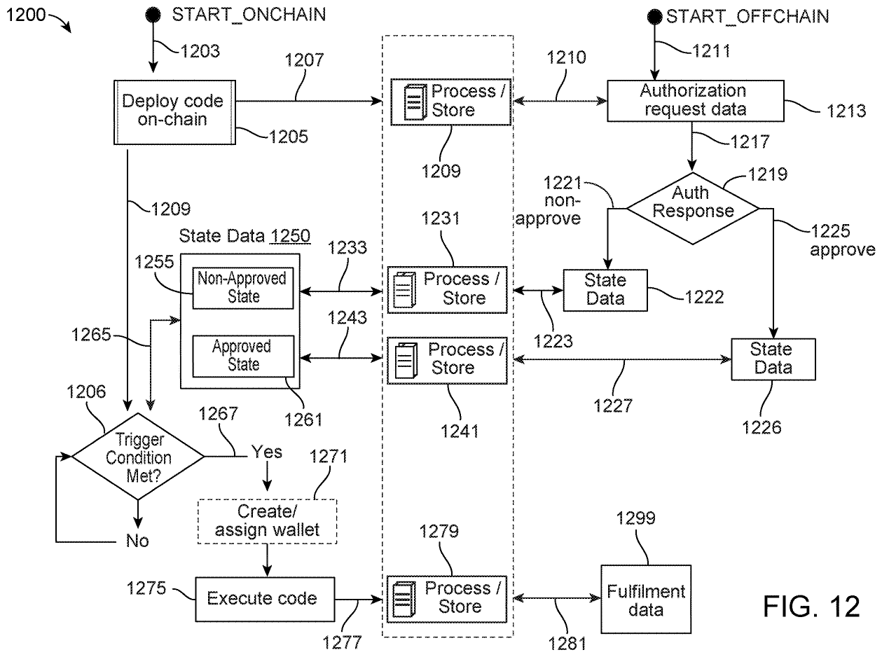

FIG. 12 is a state diagram 1200 illustrating the effect of trigger conditions, deployed via code on a blockchain, to automatically execute on-chain code based on the state of off-chain payments data. FIG. 12 illustrates the fulfillment of an order and the provision of fulfilment data for efficient and secure querying by payment network participants.

In the state diagram 1200, code 1205 is compiled and deployed on-chain at step 1203, similar to FIG. 4 step 490. Code 1205 may be contract 334 as discussed elsewhere herein. Code 1205 may include methods governing execution, which may specify the required state(s) of the transaction data (e.g., a “trigger condition”), like that described with reference to FIG. 4 step 453. Once deployed, code 1205 may automatically execute upon the satisfaction of the trigger condition 1206, such as described with reference to FIG. 6 step 611.

In step 1207, data and/or metadata about code 1205 may be provided to a data storage and processing environment 1209, similar to FIG. 5 step 526 and environment(s) 523 and 529. Such data/metadata may include any field or information that assists any entity to understand the nature of code 1205 or the assets it effects (e.g., NFT 338), such as stock-keeping unit (SKU) data, item description, item category, transaction type indicator (TTI), country, and/or any other information that may aid parties to understand, price, and/or reduce risk associated with a transaction. For example, authorization request data that may otherwise be coded as “6051” may instead be coded instead as “7922” (concert ticket), “5948” (luxury handbag), or any other suitable and/or commonly-accepted code, based on the nature of code 1205. For example, via step 1210, any of entities 302, 312, 310, 314, and/or 322 may query environment 1209 for such information, or may receive push notifications of the same. It should be appreciated that environments 1209, 1231, 1241, 1279, 523, and 529 may be the same or different environments.

In step 1211, authorization request data 1213 may be initiated and prepared by any parties. For example, data 1213 may be initiated by buyer 302 and/or seller 304, and prepared by central service 308 or any of entities 302, 312, 310, 314, and 305 as has been described elsewhere herein (e.g., at FIG. 5 steps 511 and 513). Data 1213 may include data about code 1205, accessible or queryable via step 1210, for example to aid in transaction processing. For example, data about code 1205 may be utilized to specify a transaction's merchant category code (MCC), specify a strategic merchant (which may affect the network fee that applies to the transaction), and/or specify a transaction type indicator (TTI). Such data about code 1205 may be embedded in the authorization request message 1217, which may for example be sent to issuer 312 for approval. In step 1219, an authorization response is determined wherein the transaction is either approved 1225 or non-approved 1221 as would be understood by one of skill in the art.

In step 1221, a transaction is in a “non-approved” state 1222. In the case of ISO 8583 messages, for example, this status may include any authorization response state that is not “00—Approved”. This may include pending statuses. For example, state data 1222 may hold decline data such as “05—Do Not Honor” or “51—Insufficient Funds” or any other state data as may be understood by one of skill in the art. This may include an approve pre-authorization response message and an approve authorization response message.

In step 1223, state data 1222 may be queried by and/or reported to storage environment 1231 for processing, transformation, storage, and transmission. Environment 1231 may be queried, periodically refreshed, and/or proactively reported to on-chain state data 1250 as being in a non-approved state 1255 such as described with reference to FIG. 5 steps 521-545. In an embodiment, a non-approved state 1255 would not satisfy trigger condition 1206; however, this would be subject to code 1205. Should code 1205 be written in the inverse, non-approved state 1255 could satisfy the trigger condition 1206.

In step 1225, the transaction is in an approved state 1222. In the case of ISO 8583 messages, for example, this includes a state of “00—Approved.” This may include, for example, an approve pre-authorization response message and an approve authorization response message.

In step 1227, state data 1226 may be queried by and/or reported to storage environment 1241 for processing, transformation, storage, and further transmission. Environment 1241 may be queried, periodically refreshed, and proactively reported to on-chain state data 1250 as being in an approved state 1261 such as described with reference to FIG. 5 steps 521-545. In an embodiment, an approved state 1261 would satisfy trigger condition 1206; however, this would be subject to code 1205. Should code 1205 be written in the inverse, approved state 1261 could fail to satisfy the trigger condition 1206.

In addition to approval status (or lack thereof), state data 1222 and/or state data 1226 may contain additional metadata about the transaction, such as timestamp, merchant ID, payment amount and currency, issuer and acquirer processor codes, card network token IDs, and any other information pertaining to the fiat transaction. Such information may be queried by and/or reported to storage environments 1231 and 1241 for use in matching and/or associating portions of transactions. Additionally, such additional metadata may be passed to state 1250 for use on-chain, including for use as a trigger condition 1206.

It should be appreciated that FIG. 12 steps 1211-1227 illustrate an example embodiment of a dual message payment card network flow consistent with ISO 8583 implementations; however, it should be appreciated that other payment message standards and system designs as generally known in the art may be utilized to query and update storage environments 1209, 1231, 1241, and 1279 with state data relevant to an off-chain payment transaction.

In step 1265, trigger condition 1206 may periodically query, refresh, and/or receive proactive updates about state data 1250 and the contents of storage environments 1231 and 1241 to determine when trigger conditions may be met (for example, where 435 in FIG. 4 matches to 361 in FIG. 3). Trigger condition 1206 may be absolute or may employ fuzzy logic, based on code 1205.

In step 1267, upon satisfaction of trigger condition 1206, the code 1205 may execute, and further may execute automatically without human involvement. Optionally, this may result in the creation, provisioning, assignment, and/or association of a wallet 1271 (for example, in the case of a ERC 4337 wallet factory). Upon satisfaction of trigger condition of 1206, code 1205 will execute (similar to FIG. 6 step 631), resulting in a further state 1275 noting that the code has been executed (similar to FIG. 6 step 641).

In step 1277, executed on-chain code 1275 may be queried by and/or reported to storage environment 1279 for processing, transformation, storage, and transmission. Similar to FIG. 7 step 711, this may include, for example, event log fields associated with the transaction, such as address, topics, data, blockNumber, timestamp, gasPrice, gasUsed, logIndex, transactionHash, and transactionIndex, using methods and systems that will be apparent to persons having skill in the art.

Similar to FIG. 7 step 711, data in storage environment 1279 may be supplemented with additional data to validate successful fulfilment. This may include, for example, a function (such as getOwnersForToken) that looks up NFT 338 by contractAddress and/or TokenID following the execution of code 1205 and validates its success.

In step 1281, similar to FIG. 7 step 731, environment 1279 may be queried, periodically refreshed, and/or proactively reported to one or more of entities 302, 312, 310, 314, and/or 322 and represented as 1299 fulfillment data (also sometimes referred to herein as a transaction confirmation or a transaction confirmation data element).

Applicants have surprisingly found that it is possible to efficiently and securely report transaction confirmation data to payment network participants, for use in curtailing future dispute claims in an automated fashion without requiring an investigative process for transactions which occur in a combination of on and off chain environments. Further, applicants have surprisingly found that this process successfully enables the reassociation of data evidencing an on-chain transfer of assets (such as event-logs) with an off-chain fiat payment event (such as a transaction message), offering novel and unprecedented visibility between traditional payment rails and the antithetical blockchain space for use in mitigating fraud and leakage.

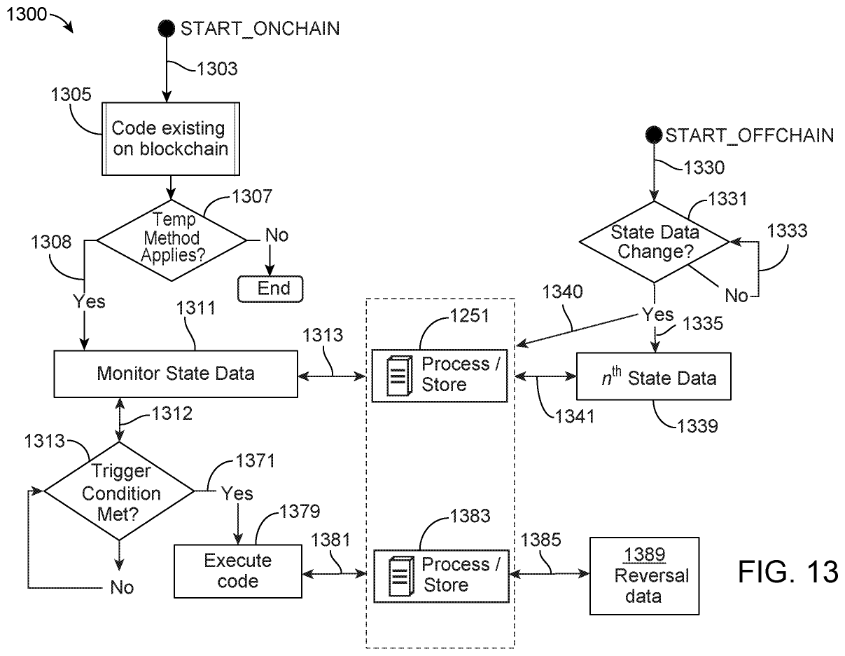

FIG. 13 is a state diagram 1300 illustrating the effect of trigger conditions, deployed via code on a blockchain, to automatically execute on-chain code based on the state of off-chain payments data. Following from FIG. 12, FIG. 13 illustrates an example embodiment for the reversal of an order and the provision of reversal data for efficient and secure querying by payment network participants. A reversal may include a voluntary refund, reversal, chargeback, and/or dispute with respect to the transaction that served as consideration for the execution of contract(s) 334.

In the state diagram 1300, code 1305 exists on-chain (similar to FIG. 6 step 641). Code 1305 is created via step 1303, following from FIG. 12 step 1267 to execute code 1275. Code 1305 enables buyer 301 to access and utilize NFT(s) 338. In step 1307, a temporary method may apply, similar to FIG. 4 methods surviving execution 465. This example temporary method may only apply to a specified time or under certain pre-defined conditions, after which or absent which a dispute step 471 cannot be invoked. For example, temporary method 469 may stipulate a hold period that has expired, thereby resulting in an END.

In step 1308, a temporary method 1307 applies, wherein state data 1311 may periodically query, refresh, and/or receive proactive updates to and from environment 1351 via step 1313, which may be similar in nature to FIG. 12 steps 1233 and 1243.

Following the authorization, clearing, and settlement of fiat transaction (such as that depicted at FIG. 12 step 1225), the payment network participants and/or parties to the transaction may observe and/or alter the transaction, effecting a change in state data 1331. For example, the buyer 301 may file a “chargeback” claim, disputing the transaction, whereby payment network participants may reverse the transaction and encumber the seller. In another example, the buyer 301 may request a refund, which seller 323 may voluntarily execute via acquirers 314, using processes as would be commonly understood by one of skill in the art. In another example, an intermediary service provider (e.g., Verifi, Ethoca) or card linked offer service may alert seller 323 to a chargeback, upon which seller 323 chooses to process a reversal.

In further example, state data changes in an ISO 8583 format may employ a message type indicator such as “reversal” (such as x4x0 or x4x1) and/or chargeback (such as x4x2 or x4x3). In another example, dispute-related transaction messages in an ISO 20022 format may employ messageID such as those relevant to chargeback initiation (cain.027.001.xx) and/or chargeback response (cain.028.001.xx), customer payment reversal (pain.007.001.xx), customer credit transfer initiation (pain.001.001.xx), and/or payment return (pacs.004.001.xx). Additionally, additional state data may include specified status of a dispute or chargeback (e.g., filed, under review, accepted).

Additionally state data may reflect the absence of state data. In another example, state data 1339 may reflect the absence of a future expected recurring transaction, as in the case of an expected monthly subscription payment that was not subsequently paid, thereby meeting a pre-defined trigger condition 1313 which executes code 1379 that removes the functionality of the on-chain NFT 338.

Similar to FIG. 5 and FIG. 8 step 811, state data changes and/or metadata thereof may become known or be communicated to environment 1351 (which may be similar to environments 523 and 529) from one or more of entities 302, 312, 310, 314, and/or 322, via message path(s) 303, 313, 311, 307, and/or 305, respectively. These changes may be communicated directly via step 1340 (similar to FIG. 5 step 527), and optionally they may be communicated indirectly via step 1335 and nth state data 1339 (similar to FIG. 5 step 521).

In addition to reversal status (or lack thereof), state data 1339 may contain additional metadata about the transaction and reversal, such as timestamp, merchant ID, transaction identifier (TraceID, TranID, ARN), payment amount and currency, issuer and acquirer processor codes, card network token IDs, and any other information pertaining to the fiat transaction. Such information may be queried by and/or reported to storage environment 1351 for use in matching transactions. Additionally, such additional metadata may be passed to state 1311 for use on-chain, including for use as a trigger condition 1313.

It should be appreciated that FIG. 13 steps 1330-1341 illustrate an example embodiment of a dual message payment card network flow consistent with ISO 8583 implementations; however, it should be appreciated that other payment message standards and system designs as are known in the art may be utilized to query and update storage environments 1351 and 1383 with state data relevant to an off-chain payment transaction. It should be appreciated that environments 1351, 1383, 1209, 1231, 1241, 1279, 523, and 529 may be the same or different environments.

In step 1312, trigger condition 1313 may periodically query, refresh, and/or receive proactive (push) updates about state data 1311 and the contents of storage environment 1351 to monitor for trigger conditions (for example, where 471 in FIG. 4 matches to 361 in FIG. 3). This is similar to the embodiment described with reference to FIG. 8 step 851. Trigger condition 1313 may be absolute or may employ fuzzy logic, based on code 1305 and dispute 471.

In step 1371, upon satisfaction of trigger condition 1313, the code 1379 may execute. This is similar to the actions described with reference to FIG. 8, step 857. Code 1379 may be similar to that of FIG. 4 dispute method 471. The execution of code 1379 may result in the permanent deletion, repatriation, loss of utility, and/or escrow of NFT 338 (as shown and described in greater detail in FIG. 8).

In step 1277, executed on-chain code 1275 may be queried and reported to storage environment 1279 for processing, transformation, storage, and transmission. Similar to FIG. 7 step 711, this may include, for example, event log fields associated with the transaction, such as address, topics, data, blockNumber, timestamp, gasPrice, gasUsed, logIndex, transactionHash, and transactionIndex, using methods and systems that will be apparent to persons having skill in the art.

In step 1385, similar to FIG. 8 step 811, environment 1383 may be queried, periodically refreshed, and/or proactively reported to one or more of entities 302, 312, 310, 314, and/or 322 and represented as 1389 reversal data (sometimes also referred to as a disputes report or a disputes formatted data set).

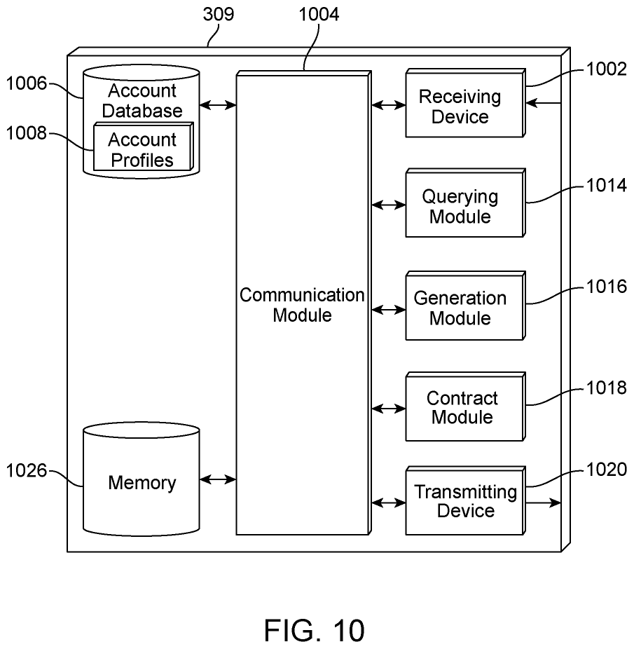

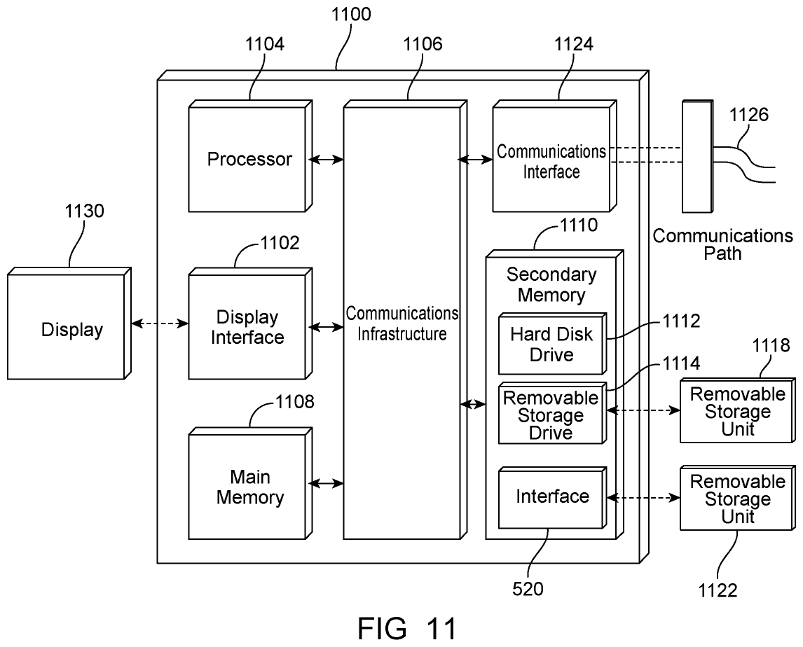

FIG. 10 illustrates an embodiment of the processors (also known as processing servers, servers, or processing devices) in the systems 100, 200, 300, and 900. It will be apparent to persons having skill in the relevant art that the embodiment of the processor illustrated in FIG. 10 is provided as illustration only and may not be exhaustive to all possible configurations of the processor suitable for performing the functions as discussed herein. For example, the computer system 1100 illustrated in FIG. 11 and discussed in more detail below may be a suitable configuration of the processor. It should be appreciated that any of the servicer 312 (including subparts), payment network 310, seller servicer 314 (including subparts), and central service 308 may include or operate via one or more processing servers as shown in FIG. 10. For example, processor 309 and processor 316 may be a processor as shown in FIG. 10. Furthermore, some or all of these processors may be networked together. It should further be appreciated that, as used herein, the processing device, storage environment, generation processor, contract processor, and communication processor, may be the processor shown in FIG. 10.

The processor (by way of non-limiting example, central service processor 309) may include a receiving device 1002. The receiving device 1002 may be configured to receive data over one or more networks via one or more network protocols. In some instances, the receiving device 1002 may be configured to receive data from payment networks 310, 990, 910, servicers 312, 912, seller servicers 314, 914, blockchain networks 350, 360, 370, 390, 970, central service 308, and other systems and entities via one or more communication methods, such as radio frequency, local area networks, wide area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 1002 may receive electronically transmitted data signals, where data may be superimposed or otherwise encoded on the data signal and decoded, parsed, read, or otherwise obtained via receipt of the data signal by the receiving device 1002. In some instances, the receiving device 1002 may include a parsing module for parsing the received data signal to obtain the data superimposed thereon. For example, the receiving device 1002 may include a parser program configured to receive and transform the received data signal into usable input for the functions performed by the processing device to carry out the methods and systems described herein.

The receiving device 1002 may be configured to receive data signals electronically transmitted by payment networks 310, 990, 910, that are transmitted via payment rails (e.g., via TCP/IP to and/or from card network servers) and superimposed or otherwise encoded with transaction messages, such as authorization requests for fiat payment transactions. The receiving device 1002 may be configured to receive data signals electronically transmitted by servicers 312, 912, and/or seller servicers 314, 914, that may be superimposed or otherwise encoded with transaction identifiers, transaction data, or other data regarding the processing of the payment transaction. The receiving device 1002 may be further configured to receive data signals electronically transmitted by blockchain networks 350, 360, 370, 390, 970, such as via blockchain nodes, indexers, remote procedure calls (RPC), and/or subgraph indexers included therein, that may be superimposed or otherwise encoded with transaction identifiers or other data regarding the processing of blockchain transactions.

The processor may also include a communication module 1004. The communication module 1004 may be configured to transmit data between modules, engines, databases, memories, and other components of the processor for use in performing the functions discussed herein. The communication module 1004 may be comprised of one or more communication types and utilize various communication methods for communications within a computing device. For example, the communication module 1004 may be comprised of a bus, contact pin connectors, wires, etc. In some embodiments, the communication module 1004 may also be configured to communicate between internal components of the processor and external components of the processor, such as externally connected databases, display devices, input devices, etc. The processor may be or include a processing device. The processing device may be configured to perform the functions of the processor discussed herein as will be apparent to persons having skill in the relevant art. In some embodiments, the processing device may include and/or be comprised of a plurality of engines and/or modules specially configured to perform one or more functions of the processing device, such as a querying module 1014, generation module 1016, contract module 1018, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processor may include an account database 1006. The account database 1006 may be configured to store a plurality of account profiles 1008 using a suitable data storage format and schema. The account database 1006 may be a relational database that utilizes structured query language for the storage, identification, modifying, updating, accessing, etc. of structured data sets stored therein. Each account profile 1008 may be a structured data set configured to store data related to a transaction account. An account profile 1008 may include, for instance, a transaction account number for the related transaction account, and other payment details associated therewith, blockchain wallet data (e.g., a private key and public key for a cryptographic key pair, unspent transaction outputs, balance data, walletID), and any other data used in the processing of fiat and cryptocurrency payment transactions, such as balances, credit information, reward data, “know your customer” data, transaction history etc., whether at an account level or at a transaction level.

The processor may include a querying module 1014. The querying module 1014 may be configured to execute queries on databases to identify information. The querying module 1014 may receive one or more data values or query strings, and may execute a query string based thereon on an indicated database, such as the account database 1006 of the processor to identify information stored therein. The querying module 1014 may then output the identified information to an appropriate engine or module of the processor as necessary. The querying module 1014 may, for example, execute a query on the account database 1006 to identify an account profile 1008 related to a fiat payment transaction using the transaction account number included in a received authorization request, such as to determine approval or denial of the fiat payment transaction based on balance and credit information. The querying module 1014 may also query whether an on-chain fulfilment has occurred, for example by performing a getOwnersForToken function, wherein the getOwnersForToken function returns a return wallet address (and then the processing device may make a determination that the NFT has been successfully delivered if the return wallet address matches the account and/or wallet owned or accessible by the buyer).

The processor may also include a generation module 1016. The generation module 1016 may be configured to generate data for use by the processor in performing the functions discussed herein. The generation module 216 may receive instructions as input, may generate data or metadata based on the instructions, and may output the generated data or metadata to one or more modules of the processor. For example, the generation module 1016 may be configured to extract, from the transaction message, at least one extracted data element and/or extracted metadata element, and/or generate, from the at least one extracted data element and/or the at least one extracted metadata element, at least one generated metadata element. The generation module 1016 may also generate a disputes report, a fulfilment confirmation report, and any other suitable or desired report.

The processor may also include a contract module 1018. The contract module 1018 may be configured to perform the functions of the processor related to the processing of smart contracts, including creating, compiling, and deploying smart contracts on a blockchain. The contract module 1018 may, for example, receive or generate an agreed set of terms, codify the agreed set of terms into bytecode, compile the smart contract, deploy the smart contract on the blockchain, seek or receive approval of the buyer and seller to the smart contract, etc.

The processor may also include a transmitting device 1020, also referred to herein as a communication device. The transmitting device 1020 may be configured to transmit data over one or more networks via one or more network protocols. In some instances, the transmitting device 1020 may be configured to transmit data to payment networks 310, 990, 910, servicers 312, 912, seller servicers 314, 914, blockchain networks 350, 360, 370, 390, 970, central service 308, and other entities via one or more communication methods, local area networks, wide area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 1020 may electronically transmit data signals that have data superimposed that may be parsed by a receiving computing device. In some instances, the transmitting device 1020 may include one or more modules for superimposing, encoding, or otherwise formatting data into data signals suitable for transmission.

The transmitting device 1020 may be configured to electronically transmit data signals to payment networks 310, 990, 910, that are superimposed or otherwise encoded with transaction messages, such as authorization requests and/or responses, for fiat payment transactions, which may be transmitted using payment rails associated with the payment network 310, 990, 910. The transmitting device 1020 may also be configured to electronically transmit data signals to servicers 312, 912, and/or seller servicers 314, 914, that may be superimposed or otherwise encoded with transaction identifiers, transaction data, or other data regarding the processing of the payment transaction. The transmitting device 1020 may be further configured to receive data signals electronically transmitted by blockchain networks 350, 360, 370, 390, 970, such as from nodes, indexers, subgraph indexers, and/or remote procedures calls (RPC) thereof, that may be superimposed or otherwise encoded with notifications and other data regarding blockchain transactions processed thereby. The transmitting device 1020 may be configured to transmit information about the smart contract, information about the buyer(s) and/or the seller, information about an off-chain fiat payment transaction and/or an on-chain order fulfilment or any other relevant information.

The processor may also include a memory 1026. The memory 1026 may be configured to store data for use by the processor in performing the functions discussed herein, such as public and private keys, symmetric keys, contractIDs, walletIDs, extract data elements, extracted metadata elements, generated metadata elements, etc. The memory 1026 may be configured to store data using suitable data formatting methods and schema and may be any suitable type of memory, such as read-only memory, random access memory, etc. The memory 1026 may include, for example, encryption keys and algorithms, communication protocols and standards, data formatting standards and protocols, program code for modules and application programs of the processing device, and other data that may be suitable for use by the processor in the performance of the functions disclosed herein as will be apparent to persons having skill in the relevant art. In some embodiments, the memory 1026 may be comprised of or may otherwise include a relational database that utilizes structured query language for the storage, identification, modifying, updating, accessing, etc. of structured data sets stored therein. The memory 1026 may be configured to store, for example, cryptographic keys, salts, nonces, communication information for blockchain nodes and blockchain networks, address generation and validation algorithms, digital signature generation and validation algorithms, cryptocurrency exchange rates, transaction message formatting standards, payment rail routing data, etc. It should be appreciated that data storage environment 523 and/or metadata storage environment 529 may be stored in memory 1026 of the processor (or of another processor associated with, networked to, and/or allowing access from the processor).

FIG. 11 illustrates a computer system 1100 in which embodiments of the present disclosure, or portions thereof, may be implemented as computer-readable code. For example, servicer 312 (including subparts), payment network 310, seller servicer 314 (including subparts), and central service 308 of FIGS. 3 and 9 may be implemented in the computer system 1000 using hardware, non-transitory computer readable media having instructions stored thereon, or a combination thereof and may be implemented in one or more computer systems or other processing systems. Hardware may embody modules and components used to implement the methods of FIGS. 4, 5, 6, and 7.

Further, the blockchain networks 350, 360, 370, 390, 970, may be comprised of a plurality of blockchain nodes. Each blockchain node may be a computing system, such as illustrated in FIG. 11, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1118, a removable storage unit 1122, and a hard disk installed in hard disk drive 1112.

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device specifically configured to perform the functions discussed herein. The processor device 1104 may be connected to a communications infrastructure 1106, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1100 may also include a main memory 1108 (e.g., random access memory, read-only memory, etc.), and may also include a secondary memory 1110. The secondary memory 1110 may include the hard disk drive 1112 and a removable storage drive 1114, such as a floppy disk drive, a magnetic tape drive, an optical disk drive, a flash memory, a removable hard disk, a cold storage device, etc.

The removable storage drive 1114 may read from and/or write to the removable storage unit 1118 in a well-known manner. The removable storage unit 1118 may include a removable storage media that may be read by and written to by the removable storage drive 1114. For example, if the removable storage drive 1114 is a floppy disk drive or universal serial bus port, the removable storage unit 1118 may be a floppy disk or portable flash drive, respectively. In one embodiment, the removable storage unit 1118 may be non-transitory computer readable recording media.

In some embodiments, the secondary memory 1110 may include alternative means for allowing computer programs or other instructions to be loaded into the computer system 1100, for example, the removable storage unit 1122 and an interface 1120. Examples of such means may include a program cartridge and cartridge interface, a removable memory chip (e.g., EEPROM, PROM, etc.) and associated socket, and other removable storage units 1122 and interfaces 1120 as will be apparent to persons having skill in the relevant art.

Data stored in the computer system 1100 (e.g., in the main memory 1108 and/or the secondary memory 1110) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a graphQL database, a distributed database, an object database, etc. Suitable configurations and storage types will be apparent to persons having skill in the relevant art.

The computer system 1100 may also include a communications interface 1124. The communications interface 1124 may be configured to allow software and data to be transferred between the computer system 1100 and external devices. Exemplary communications interfaces 1124 may include a modem, a network interface (e.g., an Ethernet card), a communications port, a PCMCIA slot and card, etc. Software and data transferred via the communications interface 1124 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 1100 may further include a display interface 1102. The display interface 1102 may be configured to allow data to be transferred between the computer system 1100 and external display 1130. Exemplary display interfaces 1102 may include high-definition multimedia interface (HDMI), digital visual interface (DVI), video graphics array (VGA), etc. The display 1130 may be any suitable type of display for displaying data transmitted via the display interface 502 of the computer system 1100, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1108 and secondary memory 1110, which may be memory semiconductors (e.g., DRAMs, etc.). These computer program products may be means for providing software to the computer system 1100. Computer programs (e.g., computer control logic) may be stored in the main memory 1108 and/or the secondary memory 1110. Computer programs may also be received via the communications interface 1124. Such computer programs, when executed, may enable computer system 1100 to implement the present methods as discussed herein. In particular, the computer programs, when executed, may enable processor device 1104 to implement the methods illustrated by FIGS. 4, 5, 6, and 7, as discussed herein. Accordingly, such computer programs may represent controllers of the computer system 1100. Where the present disclosure is implemented using software, the software may be stored in a computer program product and loaded into the computer system 1100 using the removable storage drive 1114, interface 1120, and hard disk drive 1112, or communications interface 1124.

The processor device 1104 may comprise one or more modules or engines configured to perform the functions of the computer system 1100. Each of the modules or engines may be implemented using hardware and, in some instances, may also utilize software, such as corresponding to program code and/or programs stored in the main memory 1108 or secondary memory 1110. In such instances, program code may be compiled by the processor device 1104 (e.g., by a compiling module or engine) prior to execution by the hardware of the computer system 1100. For example, the program code may be source code written in a programming language that is translated into a lower level language, such as assembly language or machine code, for execution by the processor device 1104 and/or any additional hardware components of the computer system 1100. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1100 to perform the functions disclosed herein. It will be apparent to persons having skill in the relevant art that such processes result in the computer system 1100 being a specially configured computer system 1100 uniquely programmed to perform the functions discussed above.

The phrases ‘server’ and ‘processor’ as used in this specification and claims is intended to mean, unless the context suggests otherwise, any type or form of server, processor, server system, processor system, data service, processor service, network of servers, network of processors, server platform, processor platform, server service, or processor service, including remote or cloudbased platforms, processors, systems and servers, such as those that typically provide for data processing, communication, hosting, service or server architectures and/or data storage services and functionality, whether proprietary systems, third party systems and services, or a combination.

It should be appreciated that such processor(s) and server(s) may be a computer or machine readable medium, such as a non-transitory computer readable medium.

The phrases ‘computer-readable medium’ or ‘machine-readable medium’ as used in this specification and claims should be taken to include, unless the context suggests otherwise, a single medium or multiple media. Examples of multiple media include a centralised or distributed database and/or associated caches. These multiple media store the one or more sets of computer executable instructions. The phrases ‘computer-readable medium’ or ‘machine-readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The phrases ‘computer-readable medium’ and ‘machine readable medium’ include, but are not limited to, portable to fixed storage devices, solid-state memories, optical media or optical storage devices, magnetic media, and/or various other mediums capable of storing, containing or carrying instruction(s) and/or data. The ‘computer-readable medium’ or ‘machine-readable medium’ may be non-transitory.

The term ‘comprising’ as used in this specification and claims means ‘consisting at least in part of or ‘including, but not limited to’ such that it is to be construed in an inclusive sense as opposed to an exclusive or exhaustive sense. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term ‘and/or’ means ‘and’ or ‘or’, or both.

As used herein, references to a “message,” a “letter,” and/or a “report” should be considered to comprise an electronic communication of a formatted or structured set of data and/or metadata elements.

The use of ‘(s)’ following a noun means the plural and/or singular forms of the noun.

As used herein, singular recitations (such as ‘a’ processor) are intended to include the plural (such as ‘one or more’ processors) unless specifically limited to ‘a single’ or ‘multiple.’

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function or achieves a desired result.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

In the above description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable on any type of general purpose computer system or computing device, including, but not limited to, a desktop, laptop, notebook, tablet, smart television, gaming console, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the above description, a storage medium may represent one or more devices for storing data, including read-only memory (ROM), random access memory (RAM), magnetic disk storage mediums, optical storage mediums, flash memory devices and/or other machine or computer readable mediums for storing information.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the disclosure. Additional elements or components may also be added without departing from the scope of the disclosure. Additionally, the features described herein may be implemented in software, hardware, as a business method, and/or combination thereof.

In its various aspects, embodiments of the disclosure can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or subcombinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment of the invention disclosed herein.

This disclosure may also be said broadly to consist in the parts, elements and features referred to or indicated in this disclosure, individually or collectively, and any or all combinations of any two or more said parts, elements or features, and where specific integers are mentioned herein which have known equivalents in the art to which this disclosure relates, such known equivalents are deemed to be incorporated herein as if individually set forth. Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A central service method for associating an off-chain payment transaction to an on-chain order fulfilment for the benefit of a buyer and a seller comprising:
receiving, by a receiving device, at least one transaction message associated with the off-chain payment transaction, wherein the transaction message includes at least one data element and/or at least one metadata element;
processing the transaction message with one or more processing devices, to perform at least one of:
extracting, from the transaction message, at least one extracted data element;
extracting, from the transaction message, at least one extracted metadata element; and
generating, from the at least one extracted data element and/or the at least one extracted metadata element, at least one generated metadata element;
storing, in at least one storage environment, one or more of the extracted data element, the extracted metadata element, and the generated metadata element relating to the received transaction message; and
generating, on a blockchain, at least one token and/or at least one smart contract, wherein the at least one token and/or smart contract can access the at least one storage environment storing one or more of the extracted data element, the extracted metadata element, and the generated metadata element relating to the received transaction message, and wherein the at least one token and/or smart contract includes at least one method surviving execution.

2. The method of claim 1, wherein the off-chain payment transaction and the on-chain order fulfilment do not comprise cryptocurrency.

3. The method of claim 1, wherein the transaction message is formatted according to one or more standards.

4. The method of claim 1, wherein the transaction message comprises at least one of: an authorization request, authorization response, authorization advice, authorization repeat, authorization advice response, authentication request, authentication response, clearing request, clearing response, settlement request, settlement response, payment confirmation request, payment confirmation response, recurring payment request, recurring payment response, sale, completion, refund, and force.

5. The method of claim 4, wherein the transaction message comprises a result of a 3DS (2001) or 3DS2.0 (2016) authentication attempt.

6. The method of claim 1, wherein the smart contract automatically executes itself based on the stored and accessed extracted data element, extracted metadata element, and/or generated metadata element relating to the received transaction message.

7. The method of claim 6, wherein such automatic execution comprises a creation and/or transfer of at least one NFT to an account and/or wallet held by the buyer pursuant to a transfer of fiat to an account and/or wallet held by the seller.

8. The method of claim 1, wherein at least one of the extracted data elements, the extracted metadata elements, and the generated metadata elements comprise one or more of information about the smart contract, information about an item being transferred, a categorization, information about the parties to the smart contract, information about the terms of the smart contract, and information about the transaction message.

9. The method of claim 1, wherein the transaction message comprises at least one of a: card-linked offer message, open banking message, a real-time payment message, a peer-to-peer or staged digital wallet message, a cross-border payment message, and an electronic funds transfer message.

10. The method of claim 8, further comprising communicating one or more of information about the smart contract, information about the item being transferred, a categorization, information about the parties to the smart contract, and information about the terms of the smart contract to a payment network and/or to at least one member of the payment network.

11. The method of claim 10, wherein the communicating step allows the payment network and/or member of the payment network to apply a merchant category code or transaction type indicator to the transaction other than quasi-cash or digital goods.

12. The method of claim 1, wherein the at least one method surviving execution comprises a temporary method which persists for a time period and further comprises one or more of a holding period, a dispute call, a warranty, a return policy, an insurance requirement, an insurance policy, a tax obligation, a lien on an item being transferred, and a dependency to execute at least one other contract within a follow-on time period.

13. The method of claim 7, wherein the at least one method surviving execution comprises a non-temporary method, and further comprises one or more of a permanent record of ownership of the at least one NFT, a lien on an item being transferred, an override provision, and an insurance policy.

14. The method of claim 7, wherein the smart contract comprises at least one method governing execution further comprising one or more of a required value to be achieved by state data, an on-chain signature, and a timelock key.

15. The method of claim 14, wherein the required value to be achieved by state data indicates a settlement guarantee or confirmation by a payment network and/or by at least one member of the payment network.

16. The method of claim 7, further comprising performing confirmatory processing to validate successful delivery of the NFT.

17. The method of claim 16, wherein performing confirmatory processing to validate successful delivery of the NFT comprises performing a getOwnersForToken function, wherein the getOwnersForToken function returns a return wallet address, and further comprises determining the NFT has been successfully delivered if the return wallet address matches the account and/or wallet held by the buyer.

18. The method of claim 17, further comprising receiving and/or creating at least one transaction confirmation data element, and further comprising communicating the at least one transaction confirmation data element to one or more of a sender from whom the transaction message was received, a payment network, and/or a member of the payment network.

19. A central service system to associate an off-chain payment transaction to an on-chain order fulfilment event for the benefit of a buyer and a seller comprising:
a receiving device configured to receive at least one transaction message associated with the off-chain payment transaction, wherein the transaction message includes at least one data element and/or at least one metadata element;
one or more processors associated with the receiving device and configured to process the transaction message by performing at least one of:
extracting, from the transaction message, at least one extracted data element;
extracting, from the transaction message, at least one extracted metadata element; and
generating, from the at least one extracted data element and/or the at least one extracted metadata element, at least one generated metadata element;
a storage environment associated with the processor and the receiving device, the storage environment configured to store one or more of the extracted data element, the extracted metadata element, and the generated metadata element relating to the received transaction message; and
a generation processor configured to generate, on a blockchain, at least one token and/or at least one smart contract, wherein the at least one token and/or smart contract can access the at least one storage environment storing one or more of the extracted data element, the extracted metadata element, and the generated metadata element relating to the received transaction message; and wherein the at least one token and/or smart contract includes at least one method surviving execution.

20. A non-transitory computer-readable medium storing instructions that, when executed by one or more processors of a central service, cause the one or more processors to perform a method for associating an off-chain payment transaction to an on-chain order fulfilment for the benefit of a buyer and a seller, the method comprising:
receiving, by a receiving device, at least one transaction message associated with the off-chain payment transaction, wherein the transaction message includes at least one data element and/or at least one metadata element;
processing the transaction message with one or more processing devices, to perform at least one of:
extracting, from the transaction message, at least one extracted data element;
extracting, from the transaction message, at least one extracted metadata element; and
generating, from the at least one extracted data element and/or the at least one extracted metadata element, at least one generated metadata element;
storing, in at least one storage environment, one or more of the extracted data element, the extracted metadata element, and the generated metadata element relating to the received transaction message; and
generating, on a blockchain, at least one token and/or at least one smart contract, wherein the at least one token and/or smart contract can access the at least one storage environment storing one or more of the extracted data element, the extracted metadata element, and the generated metadata element relating to the received transaction message, and wherein the at least one token and/or smart contract includes at least one method surviving execution.
